(19) United States
(12) Patent Application Publication
(10) Pub. No.: US 2025/0347395 A1
(43) Pub. Date: Nov. 13, 2025

(54) LIGHTING ASSEMBLY

(71) Applicant: Häfele UK Limited, Warwickshire (GB)

(72) Inventor: Tom Michael Fletcher, Buckinghamshire (GB)

(73) Assignee: Häfele UK Limited, Warwickshire, EN (GB)

(21) Appl. No.: 19/279,123

(22) Filed: Jul. 24, 2025

Related U.S. Application Data
(63) Continuation of application No. PCT/GB2024/050183, filed on Jan. 24, 2024.

(30) Foreign Application Priority Data
Jan. 25, 2023 (GB) 2301064.8
Mar. 6, 2023 (GB) 2303228.7

(51) Int. Cl. F21S 4/28

(52) U.S. Cl. CPC F21S 4/28

(57) ABSTRACT

A lighting assembly is provided with a flexible elongate body extending between first and second ends thereof. The body has a base wall and a light transmissive cover. A lighting strip extends at least partially along the chamber. The lighting strip includes a plurality of light emitting members at least partially covered by the light transmissive cover. The body has a mounting arrangement configured to mount the lighting strip to the support. The mounting arrangement includes a first mounting formation on an outer surface of the elongate body. The mounting formation includes a recess, groove or channel on the outer surface of the body.

### CROSS-REFERENCE TO RELATED APPLICATIONS

This continuation application claims priority to PCT/GB2024/050183 filed on Jan. 24, 2024, which has published as WO 2024/157002 A1 and also the United Kingdom application numbers GB 2301064.8 filed on Jan. 25, 2023 and GB 2303228.7 filed on Mar. 6, 2023, the entire contents of which are fully incorporated herein with these references.

### DESCRIPTION

### Field of the Invention

The present teachings relate to a lighting assembly, for example a lighting assembly for mounting to a support such as a frame assembly or lighting support, and to a lighting support.

### Background of the Invention

Lighting assemblies are used in numerous applications, for example as decorative lighting in commercial settings where the lighting is installed in frame assemblies for discrete display or in domestic settings to be mounted to lighting supports or profiles for mounting to a plinth or pane in kitchens. Lighting assemblies typically include a light emitting diode (LED) lighting strip within with a series of LED emitters arranged along the length of the lighting strip. The lighting strip is then typically encased within a body to seal the lighting strip. Known lighting assemblies are often relatively inflexible, meaning the versatility of their use is limited because they cannot be used in applications with spatial restrictions. As such, in these known lighting assemblies, a series of separate light strips may need to be used.

The present teachings seek to provide an improved lighting assembly and/or an improved lighting support.

### SUMMARY OF THE INVENTION

A first aspect of the teachings provides a lighting assembly for mounting to a lighting support, the lighting assembly comprising: a flexible elongate body extending between first and second ends thereof, said body comprising a base wall, and a light transmissive cover; a lighting strip extending at least partially along the flexible elongate body and located within or connected to the elongate flexible body so as to be at least partially covered by the light transmissive cover; wherein the body comprises a mounting arrangement configured to mount the lighting strip to the support, wherein the mounting arrangement comprises a first mounting formation on an outer surface of the elongate body, said mounting formation comprising a recess, groove or channel on the outer surface of the body.

Advantageously, the mounting arrangement improves fitting of the lighting assembly and correctly positions the lighting assembly relative to the support. The use of the recess, groove or channel negates the need for an adhesive, for example a tape, which may come loose when the lighting assembly heats up.

The mounting arrangement may be configured to releasably mount the lighting assembly to the lighting support. Advantageously, the releasable mounting enables the lighting assembly to be re-assembled to different supports.

The flexible elongate body may be resiliently deformable. Advantageously, providing a resiliently deformable body helps to facilitate mounting of the lighting strip to the support because the lighting assembly can deform while fitting to the support and then expand to positively engage with the recess of the support. The flexible elongate body may be resiliently deformable along an axis substantially perpendicular to first mounting formation. The first mounting formation may be arranged on a first lateral side of the body, and the body may be resiliently deformable along a lateral axis.

The mounting arrangement may comprise a second mounting arrangement on a second lateral side of the body opposite the first lateral side and wherein the body may be resiliently deformable along an axis extending between the first and second mounting formations.

Advantageously, this means that the flexible elongate body deforms when compressed in the direction extending between the first and second mounting formations. When the flexible elongate body is released, this enables the first and second mounting formations to positively engage with the support. The second mounting formation may comprise a recess, groove or channel.

The light transmissive cover and/or the base of the flexible elongate body may be resiliently deformable such that the body can be laterally compressed. Advantageously, the deformation of the light transmissive cover helps to mount the lighting assembly to the support. Resilient deformation of the light transmissive cover and base may also be advantageous when the mounting arrangement is located on the light transmissive cover or the base wall.

The body may comprise first and second side walls extending between the base wall and the light transmissive cover, wherein the side walls of the flexible elongate body may be resiliently deformable such that the body can be laterally compressed. Advantageously, the first and second side walls help to enclose the lighting strip at least partially within the body to create a tight seal around the lighting strip and makes the lighting assembly IP44 compliant. Additionally, the first and second side walls may be used to mount the lighting assembly to the support.

Advantageously, lateral compression in the direction extending between the first and second mounting formations means that when the lighting assembly is inserted, the side walls can deform around the support. When the flexible elongate body is released, this enables the first and second mounting formations to positively engage with the support.

Each mounting formation may define a shoulder configured and arranged to abut against the support when the lighting assembly is mounted to the lighting support. Advantageously, the wall controls the depth of the lighting assembly within the recess, thereby correctly aligning the lighting assembly in the depth direction.

The mounting arrangement may be a push-fit or snap-fit mounting arrangement. The mounting arrangement may be configured to provide a push-fit or snap-fit connection to the lighting support. Advantageously, push-fit or snap-fit mounting arrangements can provide releasable mounting that do not require additional components to mount the lighting assembly to the support. Moreover, providing a push-fit or snap-fit mounting arrangement enables the lighting assembly to be mounted perpendicular to the lighting support (i.e., front on) and removes the need for the lighting assembly to be mounted at an end of the lighting support and then slid along into position.

The body may define an internal elongate chamber extending between the first and second ends, and wherein the lighting strip extends at least partially along the chamber.

The lighting strip and the chamber may be dimensioned such that the lighting strip is moveable within the chamber.

The lighting strip and the chamber may be dimensioned such that the lighting strip is moveable within the chamber along an axis substantially perpendicular to the elongate axis of the body.

The lighting strip and the chamber may be dimensioned such that the lighting strip is moveable within the chamber along a first axis extending between the light transmissive cover and the base wall, and/or along a second axis extending between the first and second side walls.

The lighting strip and the chamber may be dimensioned to prevent the light strip from twisting and/or rotating such that the light emitting members face in a direction away from the light transmissive cover.

The chamber may define a first height along a first axis extending between the base wall and the cover, and the lighting strip may define a second width extending along a second axis extending between the first and second side walls, and the second width may be greater than the first height.

The first height may be greater than the second height by a distance in the range 0.1 mm to 3 mm.

The chamber may define a first width along a second axis extending between the first and second side walls, the lighting strip may define a second width along the second axis, and the first width may be greater than the second width.

The first width may be greater than the second width by a distance in the range 0.1 mm to 5 mm.

The cover may be configured to diffuse light emitted by the plurality of light emitting members.

The light transmissive cover may comprise an external cover surface remote from the base wall, and the external cover surface may be curved, for example continuously curved.

The external cover surface may be arcuate.

The external cover surface may comprise a radius of curvature in the range 3 mm to 15 mm. The external cover surface may comprise a radius of curvature in the range 5 mm to 13 mm.

The base wall may define an exterior base surface that is substantially planar.

The lighting assembly according to any preceding claim, wherein the first side wall, the second side wall, and the base wall are at least partially manufactured from a polymer material, for example a silicone material.

The first side wall, the second side wall, and the base wall may be integrally formed.

The cover may be at least partially manufactured from a polymer material, for example a silicone material.

The light transmissive cover may comprise a diffusion material configured to enable the diffusion of light therethrough, optionally wherein the diffusion material is provided as a coating or is mixed with the polymer material.

The first and second ends of the flexible elongate body may comprise end covers configured to seal the chamber, optionally wherein the end covers comprise a polymer material, for example a silicone material.

The lighting strip may comprise at least one length adjustment formation offset from the light emitting members, optionally wherein the lighting strip comprises a length adjustment formation between each adjacent pair of light emitting members.

The base wall may be substantially transparent or translucent such that the length adjustment formation is visible from an exterior side of the lighting assembly.

The length adjustment formation may include a mark, a detent and/or a recess.

The ratio of the first width w₁ to the first height h₁ may be in the range 10:1 to 2:5, for example in the range 7:1 to 1:1, for example in the range 6:1 to 2:1.

A second aspect of the teachings provides a lighting support for mounting to a plinth or a panel, the lighting support comprising: an elongate body defining opposing ends thereof; first and second opposing arms extending from the elongate body to define a channel configured to receive a part of a plinth or a panel therein to mount the lighting support to said plinth or panel; and a lighting mount connected to the body and comprising an elongate recess defining first and second opposing side walls extending at least partially along the elongate length of the body, wherein the first recess wall comprises a protrusion configured to engage a recess, groove or channel of a lighting assembly to mount a lighting assembly in the recess.

Advantageously, the lighting mount improves fitting of the lighting assembly to the lighting support and correctly positions the lighting assembly relative to the support. Advantageously, the second mounting arrangement enables the lighting support to be mounted to a support in the form of a separate product or device. The support may be the body of a plinth, or a splash board.

The first and second arms may be arranged such that the channel tapers in a direction away from the elongate body. This arrangement enables the lighting support (i.e., the first and second arms) to engage the plinth or support by and exerting a gripping force thereon.

The lighting mount may be configured to releasably mount the lighting assembly to the lighting support. Advantageously, the releasable mounting enables different lighting assemblies to be re-assembled to the lighting support.

The lighting support may be deformable such that the first and second arms are deflectable relative to each other. Advantageously, this facilitates mounting the lighting support to the plinth or panel.

The channel may be arranged at a non-zero angle relative to the recess. An axis normal to an elongate opening of the channel may be arranged at a non-zero angle to an axis normal to an elongate opening of the recess. Advantageously, the relative angles enable the light emitted from the lighting assembly to be projected in front of the lighting support.

The first and second arms may each define a respective height, the height of the second arm being greater than the height of the first arm, and wherein the recess is on the first arm. The recess may be located on the first arm or the second arm.

The second recess wall may comprise a protrusion configured to engage a recess, groove or channel of a lighting assembly to mount a lighting assembly in the recess, said protrusion may be arranged to substantially oppose the protrusion on the first recess wall. Advantageously, the first and second light mounting formations help to ensure the correct positioning on both sides of the lighting assembly.

The protrusion on the first recess wall and/or second recess wall may define an external wall located towards the opening of the recess and an interior wall located towards the base wall of the recess, and the internal wall may be chamfered. Advantageously, the chamfered internal wall guides the lighting assembly out of the lighting support during removal of the lighting assembly. In embodiments where the lighting assembly is resiliently deformable, the internal chamfered wall helps to compress the lighting assembly and facilitates removal of the lighting assembly from the lighting support.

The protrusion on the first recess wall and/or second recess wall may define an external wall located towards the opening of the recess and an interior wall located towards the base wall of the recess, wherein the external wall extends substantially perpendicularly to the first or second wall. This arrangement of external wall provides a surface for the groove, recess or channel of a lighting assembly to abut against to ensure correct fitting of the lighting assembly to the lighting support.

The or each protrusion may comprise a plurality of spaced apart protrusions. Advantageously, the series of light mounting formations helps to securely mount the lighting assembly to the lighting support along the length of the elongate body. Additionally, the space between the series of light mounting formations provides space into which the lighting assembly may move, for example when the lighting support has a corner.

The recess may comprise a ledge extending from or near a distal end of the first and/or second wall to extend at least partially between said first and second walls.

The ledge may at least partially extend between adjacent protrusions. Advantageously, the ledge acts as a stopper and helps to prevent the lighting assembly from falling out of the lighting support at locations between light mounting formations. This may be particularly advantageous, for example, when the lighting support is provided with corners and it is useful to have spaces free from mounting formations.

The lighting support may comprise a lighting assembly according to the first, third or fifth aspect mounted in the recess of the lighting mount.

A third aspect of the present teachings relate to a lighting assembly for mounting to a support, the lighting assembly comprising: a flexible elongate body extending between first and second ends thereof, said body comprising a base wall, a light transmissive cover, and first and second side walls extending between the base wall and the light transmissive cover arranged to define an internal elongate chamber extending between the first and second ends; and a lighting strip extending at least partially along the chamber, said lighting strip comprising a plurality of light emitting members arranged at least partially along the lighting strip; wherein the lighting strip and the chamber are dimensioned such that the lighting strip is moveable within the chamber.

Advantageously, the lighting strip being moveable within the chamber enables the lighting strip to flex within the chamber, thereby improving the overall flexibility of the lighting assembly. This improves the versatility of the lighting assembly as it can be used in supports with tighter spatial requirements.

Optionally, the lighting strip and the chamber are dimensioned such that the lighting strip is moveable within the chamber along an axis substantially perpendicular to the elongate axis of the body.

Optionally, the lighting strip and the chamber are dimensioned such that the lighting strip is moveable within the chamber along a first axis extending between the light transmissive cover and the base wall, and/or along a second axis extending between the first and second side walls. Advantageously, the lighting strip being moveable in two directions increases the degrees of flex of the lighting strip, thereby increasing the versatility of the lighting assembly.

Optionally, the chamber defines a first height along a first axis extending between the base wall and the cover and the lighting strip defines a second height along the first axis, and wherein the first height is greater than the second height. Advantageously, the difference in the first and second heights provides space into which the lighting strip can flex in the height direction.

Optionally, the first height is greater than the second height by a distance in the range 0.1 mm to 3 mm, optionally in the range 0.1 mm to 1 mm, optionally in the range 0.2 mm to 0.8 mm, optionally in the range 0.3 mm to 0.7 mm, optionally in the range 0.4 mm to 0.6 mm. Advantageously, distances in this range have been found to allow the lighting strip to flex within the chamber, whilst restricting movement of the lighting strip within the chamber. This helps to prevent the lighting strip from twisting and/or rotating such that the lighting strip faces the wrong direction.

Optionally, the chamber defines a first width along a second axis extending between the first and second side walls, wherein the lighting strip defines a second width along the second axis, and wherein the first width is greater than the second width. Advantageously, the difference in the first and second widths provides space into which the lighting strip can flex in the width direction.

Optionally, the first width is greater than the second width by a distance in the range 0.1 mm to 5 mm, optionally in the range 0.1 mm to 3 mm, optionally in the range 0.3 mm to 1.1 mm, optionally in the range 0.5 mm to 0.9 mm, optionally in the range 0.6 mm to 0.8 mm. Advantageously, distances in this range have been found to allow the lighting strip to flex within the chamber, whilst restricting movement of the lighting strip within the chamber. This helps to prevent the lighting strip from twisting and/or rotating such that the lighting strip faces the wrong direction.

Optionally, the first width is greater than the first height. Advantageously, the shape of the chamber conforms to the shape of the lighting strip, thereby enabling improved flexibility of the lighting assembly in more than one direction.

Optionally, the first width is substantially perpendicular to the first height.

Optionally, the cover is configured to diffuse light emitted by the plurality of light emitting members. Advantageously, light diffusion materials soften and spread light, reducing the contrast ratio between hot-spot areas above the light emitting members and the regions between said light emitting members.

Optionally, the light transmissive cover comprises an external cover surface remote from the base wall, and the external cover surface is curved, for example continuously curved. Advantageously, the upper exterior surface acting as a light diffuser improves the light quality and therefore the overall aesthetics of the lighting assembly. The curved wall has been found to optimise light diffusion compared to, for example, a substantially planar wall, thereby further improving the aesthetic of the lighting assembly.

Optionally, the external cover surface is arcuate. Advantageously, the arcuate profile has been found to optimise light diffusion by creating a more even diffusion of light, thereby improving the aesthetics of the lighting assembly.

Optionally, the external cover surface comprises a radius of curvature in the range 3 mm to 15 mm, optionally in the range 5 mm to 13 mm, optionally in the range 7 mm to 11 m. Advantageously, radii in these ranges have been found to further optimise light diffusion whilst being simple to manufactured and suitable for use with supports of a variety of sizes.

Optionally, the base wall defines an exterior base surface that is substantially planar. Advantageously, this facilitates mounting of the lighting assembly.

Optionally, the first side wall, the second side wall, and the base wall are at least partially manufactured from a polymer material, for example a silicone material. Advantageously, this arrangement provides a flexible elongate body of the lighting assembly.

Optionally, the first side wall, the second side wall, and the base wall and the light transmissive cover are integrally formed.

Optionally, the light transmissive cover is at least partially manufactured from a polymer material, for example a silicone material.

Optionally, the light transmissive cover comprises a diffusion material configured to enable the diffusion of light therethrough.

Optionally, the diffusion material is provided as a coating or is mixed with the polymer material. Advantageously, light diffusion materials soften and spread light, reducing the contrast ratio between hot-spot areas above the light emitting members and the regions between said light emitting members.

Optionally, the first and second ends of the flexible elongate body comprise end covers configured to seal the chamber, optionally wherein the end covers comprise a polymer material, for example a silicone material. Advantageously, the complete enclosure of the lighting assembly within the chamber creates a tight seal and makes the lighting assembly IP44 compliant.

Optionally, the lighting strip comprises at least one length adjustment formation offset from the light emitting members, optionally wherein the lighting strip comprises a length adjustment formation between each adjacent pair of light emitting members. Advantageously, the length adjustment formation indicates to the user locations at which the lighting strip may be cut without damaging the lighting strip. This improves the versatility of the lighting assembly.

Optionally, the base wall is substantially transparent or translucent such that the length adjustment formation is visible from an exterior side of the lighting assembly. Advantageously, the transparent base wall enables the length adjustment formation to be visible to the user.

Optionally, the length adjustment formation includes a mark, a detent and/or a recess. Advantageously, these features are simple to manufacture and provide a simple indication to the user of appropriate locations at which to cut the lighting strip.

Optionally, the flexible elongate body comprises a mounting arrangement configured to mount the lighting assembly to the recess of the supporting component. Advantageously, the mounting arrangement improves fitting of the lighting assembly and correctly positions the lighting assembly relative to the support.

Optionally, the mounting arrangement comprises a first mounting formation located on the first side wall, and a second mounting formation located on the second side wall. Advantageously, the first and second mounting formations help to ensure the correct positioning on both sides of the lighting assembly.

Optionally, the first and second mounting formations comprise a recess, groove or channel at least partially defined by the first and second side wall, respectively.

Optionally, the first and second mounting formations comprise a recess, groove or channel at least partially defined by the light transmissive cover. Advantageously, the recess, groove or channel is simple to manufacture and does not require additional components to mount the lighting assembly to the support. For example, the use of the recess, groove or channel negates the need for an adhesive, for example a tape, which may come loose when the lighting assembly heats up.

The lighting strip and the chamber may be dimensioned to prevent the light strip from twisting and/or rotating such that the light emitting members face in a direction away from the light transmissive cover.

The chamber may define a first height along a first axis extending between the base wall and the cover, and the lighting strip may define a second width extending along a second axis extending between the first and second side walls, and the second width may be greater than the first height.

The flexible elongate body may be resiliently deformable.

The flexible elongate body may be resiliently deformable along an axis substantially perpendicular to the first mounting formation.

The first mounting formation may be arranged on a first lateral side of the body, and the body may be resiliently deformable along a lateral axis.

The mounting arrangement may comprise a second mounting arrangement on a second lateral side of the body opposite the first lateral side and the body may be resiliently deformable along an axis extending between the first and second mounting formations.

The light transmissive cover and/or the base of the flexible elongate body may be resiliently deformable such that the body can be laterally compressed.

The body may comprise first and second side walls extending between the base wall and the light transmissive cover, the side walls of the flexible elongate body may be resiliently deformable such that the body can be laterally compressed.

Each mounting formation may define a shoulder configured and arranged to abut against the support when the lighting assembly is mounted to the lighting support.

The mounting arrangement may be a push-fit or snap-fit mounting arrangement.

The ratio of the first width w₁ to the first height h₁ may be in the range 10:1 to 2:5, for example in the range 7:1 to 1:1, for example in the range 6:1 to 2:1.

A fourth aspect of the present teachings relates to a method of manufacturing a lighting assembly, the method comprising the steps of: coextruding a flexible elongate body defining first and second ends and comprising a base wall, a light transmissive cover, and first and second side walls extending between the base wall and the light transmissive cover arranged to define an internal elongate chamber extending between the first and second ends; inserting a lighting strip into the first end of the second of the flexible elongate body such that the lighting strip extends at least partially along the chamber, said lighting strip comprising a plurality of light emitting members arranged at least partially along the lighting strip; wherein the lighting strip and the chamber are dimensioned such that the lighting strip is moveable within the chamber.

Optionally, the method comprises the step of providing end covers at the first and second ends of the flexible elongate body to seal the chamber.

A fifth aspect of the present teachings relates to a lighting assembly for mounting to a support, the lighting assembly comprising: a flexible elongate body extending between first and second ends thereof, said body comprising a base wall, and a light transmissive cover; a lighting strip extending at least partially along the flexible elongate body and located within or connected to the elongate flexible body; and a mounting arrangement configured to mount the lighting strip to the support.

Advantageously, the mounting arrangement improves fitting of the lighting assembly and correctly positions the lighting assembly relative to the support.

Optionally, the body may comprise first and second side walls extending between the base wall and the light transmissive cover.

Optionally, the mounting arrangement is configured to releasably mount the lighting strip to the support. Advantageously, the releasable mounting enables the lighting assembly to be re-assembled to different supports.

Optionally, the mounting arrangement is configured to mount the lighting assembly to a recess of the support.

Optionally, the mounting arrangement comprises a first mounting formation located on the first side wall, and a second mounting formation located on the second side wall. Advantageously, the first and second mounting formations help to ensure the correct positioning on both sides of the lighting assembly.

Optionally, the first and/or second mounting formations comprises a recess, groove or channel at least partially defined by the first and second wall, respectively.

Optionally, the first and/or second mounting formations are at least partially defined by the light transmissive cover. Advantageously, the recess, groove or channel is simple to manufacture and does not require additional components to mount the lighting assembly to the support. For example, the use of the recess, groove or channel negates the need for an adhesive, for example a tape, which may come loose when the lighting assembly heats up.

Optionally, the first and second mounting formations each define a wall located towards the light transmissive cover, and the wall is configured to abut against the recess of the support. Advantageously, the wall controls the depth of the lighting assembly within the recess, thereby correctly aligning the lighting assembly in the depth direction.

Optionally, a series of first and second mounting formations are located along the first and second side walls.

Optionally, the flexible elongate body is resiliently deformable.

Advantageously, providing a resiliently deformable body helps to facilitate mounting of the lighting strip to the support because the lighting assembly can positively engage with the recess of the support.

Optionally, the flexible elongate body is resiliently deformable along an axis extending between the first and second mounting formations.

Optionally, the light transmissive cover and the base of the flexible elongate body are resilient deformable such that the body can be laterally compressed.

Optionally, the side walls of the flexible elongate body are resiliently deformable such that the body can be laterally compressed.

Optionally, the mounting arrangement is a push-fit arrangement. Optionally, the mounting arrangement is a snap-fit arrangement.

The lighting strip and the chamber may be dimensioned such that the lighting strip is moveable within the chamber.

The lighting strip and the chamber may be dimensioned such that the lighting strip is moveable within the chamber along an axis substantially perpendicular to the elongate axis of the body.

The lighting strip and the chamber may be dimensioned such that the lighting strip is moveable within the chamber along a first axis extending between the light transmissive cover and the base wall, and/or along a second axis extending between the first and second side walls.

The lighting strip and the chamber may be dimensioned to prevent the light strip from twisting and/or rotating such that the light emitting members face in a direction away from the light transmissive cover.

The chamber may define a first height along a first axis extending between the base wall and the cover, and the lighting strip may define a second width extending along a second axis extending between the first and second side walls, and the second width may be greater than the first height.

The first height may be greater than the second height by a distance in the range 0.1 mm to 3 mm.

The chamber may define a first width along a second axis extending between the first and second side walls, the lighting strip may define a second width along the second axis, and the first width may be greater than the second width.

The first width may be greater than the second width by a distance in the range 0.1 mm to 5 mm.

The cover may be configured to diffuse light emitted by the plurality of light emitting members.

The light transmissive cover may comprise an external cover surface remote from the base wall, and the external cover surface may be curved, for example continuously curved.

The external cover surface may be arcuate.

The external cover surface may comprise a radius of curvature in the range 3 mm to 15 mm. The external cover surface may comprise a radius of curvature in the range 5 mm to 13 mm.

The base wall may define an exterior base surface that is substantially planar.

The lighting assembly according to any preceding claim, wherein the first side wall, the second side wall, and the base wall are at least partially manufactured from a polymer material, for example a silicone material.

The first side wall, the second side wall, and the base wall may be integrally formed.

The cover may be at least partially manufactured from a polymer material, for example a silicone material.

The light transmissive cover may comprise a diffusion material configured to enable the diffusion of light therethrough, optionally wherein the diffusion material is provided as a coating or is mixed with the polymer material.

The first and second ends of the flexible elongate body may comprise end covers configured to seal the chamber, optionally wherein the end covers comprise a polymer material, for example a silicone material.

The lighting strip may comprise at least one length adjustment formation offset from the light emitting members, optionally wherein the lighting strip comprises a length adjustment formation between each adjacent pair of light emitting members.

The base wall may be substantially transparent or translucent such that the length adjustment formation is visible from an exterior side of the lighting assembly.

The length adjustment formation may include a mark, a detent and/or a recess. The ratio of the first width w₁ to the first height h₁ may be in the range 10:1 to 2:5, for example in the range 7:1 to 1:1, for example in the range 6:1 to 2:1.

According a sixth aspect, there is provided a lighting support in the form of a frame assembly, the frame assembly comprising: a plurality of elongate profiled support members, wherein at least one elongate profiled support member comprises a recess or channel extending along an elongate length thereof, and comprises a first mounting arrangement for mounting a lighting assembly in the recess of channel, and

wherein a lighting assembly according to the according to the first, third or fifth aspect is mounted in the recess or channel of the at least one elongate profiled support member.

Optionally, wherein first and second elongate profiled support members are connected at ends thereof and each comprise a recess or channel extending along an elongate length thereof, and wherein the lighting assembly is mounted in the recess of channel of each elongate profiled support member.

Optionally, wherein first and second elongate profiled support members are arranged substantially perpendicularly to each other.

### BRIEF DESCRIPTION OF THE DRAWINGS

Embodiments will now be described with reference to the accompanying drawings, in which:

FIG. 1 is an isometric view of a part of a lighting assembly according to an embodiment;

FIG. 2 is cross-sectional view of the lighting assembly of FIG. 1;

FIG. 3 is a plan view of the lighting assembly of FIG. 1;

FIG. 4 is an isometric exploded view of a support for mounting a lighting assembly thereto;

FIG. 5 is a cross-sectional view of a support of the embodiment of FIG. 4 with a lighting assembly mounted thereto;

FIG. 6 is a cross-sectional view of a lighting assembly according to an embodiment;

FIG. 7a is an isometric view of a lighting support according to an embodiment with a lighting assembly mounted thereto;

FIG. 7b is an isometric view of the lighting support of FIG. 7a;

FIG. 8 is a cross-sectional view of the lighting support of FIG. 7a;

FIGS. 9a and 9b are cross-sectional views of further lighting supports according to embodiments; and

FIG. 10 is an isometric view of a lighting support according to an embodiment.

### DETAILED DESCRIPTION OF EMBODIMENTS OF THE INVENTION

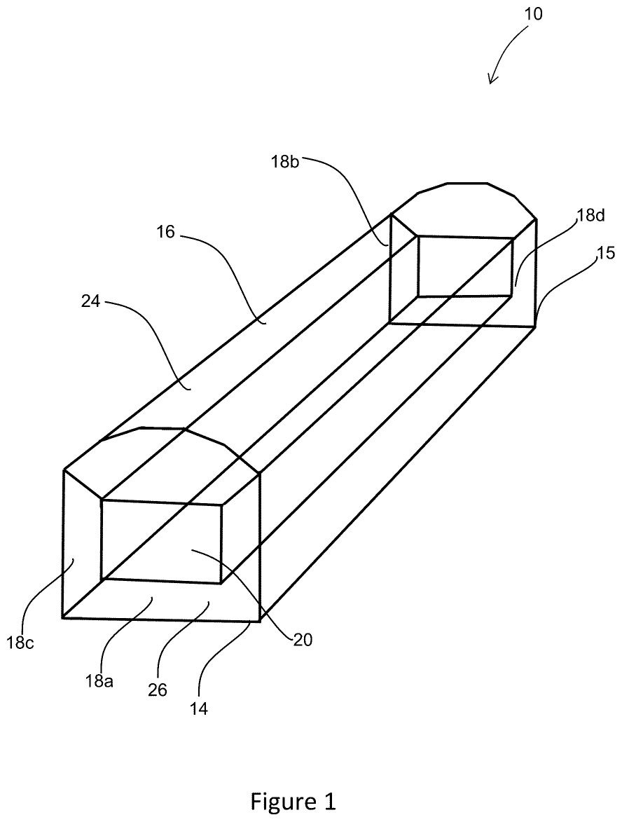

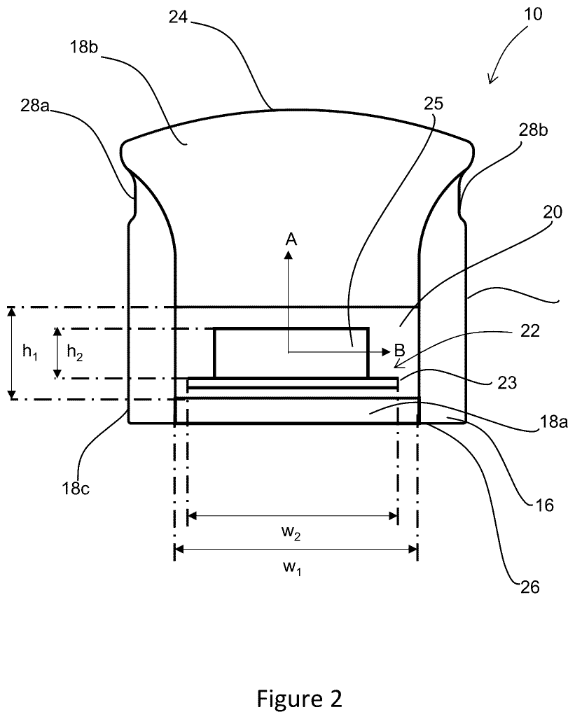

Referring to FIGS. 1 and 2, a lighting assembly 10 is illustrated. The lighting assembly 10 includes a flexible elongate body 16 extending between first 14 and second 15 ends thereof. The lighting assembly 10, for example the body 16 of the lighting assembly 10, may be configured for mounting to a lighting support, such as a frame or a plinth.

The flexible elongate body 16 includes a base wall 18a, a light transmissive cover 18b and first and second side walls 18c, 18d extending between the base wall 18a and the light transmissive cover 18b. The base wall 18a, light transmissive cover 18b, first side wall 18c and second side wall 18d are arranged to define an internal elongate chamber 20 extending between the first and second ends 14, 15. Put another way, the internal surfaces of the base wall 18a, light transmissive cover 18b, first side wall 18c and second side wall 18d define the chamber 20. In the illustrated embodiment, the base wall 18a and the light transmissive cover 18b are parallel to one another, and the first and second side walls 18c, 18b are parallel to one another. Put another way, in the embodiment the chamber 20 is substantially rectangular. It shall be appreciated that in alternative embodiments the base wall 18a, light transmissive cover 18b and first and second side walls 18c, 18b may be angled relative to one another or may be curved etc. Put another way, in alternative embodiments, the chamber 20 may be any suitable shape, such as circular, elliptical, square or any other suitable shape.

The lighting assembly 10 includes a lighting strip 22 extending at least partially along the chamber 20. The lighting strip 22 has an elongate body 23. The lighting strip 22 includes a plurality of light emitting members 25 arranged at least partially along a length of the lighting strip 22, for example entirely along the length of the lighting strip 22. The light emitting members may, by way of example, be light emitting diodes, incandescent bulbs or florescent bulbs. Any suitable number of light emitting members may be distributed along the lighting strip 22 depending, for example, on the required length of the lighting strip 22. In some embodiments, the light emitting members may be evenly distributed along the lighting strip 22, in other embodiments the light emitting members may be unevenly distributed along the lighting strip 22.

The lighting strip 22 and the chamber 20 are dimensioned such that the lighting strip 22 is moveable within the chamber 20. The lighting strip 22 being moveable within the chamber enables the lighting strip 22 to flex within the chamber 20, thereby improving the overall flexibility of the lighting assembly 10.

In some embodiments, the lighting strip 22 and the chamber 20 may be dimensioned such that the lighting strip 22 is moveable within the chamber 20 along two axes substantially perpendicular to the elongate length of the body 16. The lighting strip 22 and the chamber 20 may be dimensioned such that the lighting strip 22 is moveable within the chamber 20 along a first axis A extending between the base wall 18a and the light transmissive cover 18b. The lighting strip 22 and the chamber 20 may be dimensioned such that the lighting strip 22 is moveable within the chamber 20 along a second axis B extending between the first and second side walls 18c, 18d. In some embodiments, the first axis A may be substantially perpendicular to the second axis B. It shall be appreciated that in alternative embodiments, the lighting strip 22 may be moveable along one or both of the first and second axes A, B.

The chamber 20 defines a first height h₁ extending along the first axis A between the base wall 18a and the light transmissive cover 18b. The chamber 20 defines a first width w₁ extending along the second axis B between the first and second side walls 18c, 18b. In some embodiments, the first width w₁ may be greater than the first height h₁. The first width w₁ is perpendicular to the first height h₁. It shall be appreciated that is embodiments with alternative profiles of chamber, the first height may not be perpendicular to the first width.

The lighting strip 22 defines a second height h₂ extending along the first axis A. The lighting strip 22 defines a second width w₂ extending along the second axis B.

The first height h₁ is greater than the second height h₂. The difference in the first and second heights h₁, h₂ creates a clearance between the lighting strip 22 and the upper and lower walls of the chamber 20 (i.e., the light transmissive cover 18b and the base wall 18a). This clearance creates the space into which the lighting strip 22 is able to flex.

The first width w₁ is greater than the second width w₂. The difference in the first and second widths w₁, w₂ creates a clearance between the lighting strip 22 and the sides of the chamber (i.e., the first and second side walls 18c, 18d). The width clearance creates the space into which the lighting strip 22 is able to flex. The first width w₁ may, by way of example, be in the range 2 mm to 10 mm. The first width w₁ may, for example, be in the range 3 mm to 7 mm, or in the range 4 mm to 6 mm. The first height h₁ may, by way of example, be in the range 1 mm to 5 mm. The first height h₁ may be in the range 1 mm to 3 mm, or in the range 1 mm to 2 mm. The ratio of the first width w₁ to the first height h₁ may be in the range 10:1 to 2:5, for example in the range 7:1 to 1:1, for example in the range 6:1 to 2:1. In some embodiments, the first height h₁ is greater than the second height h₂ by a distance in the range 0.1 mm to 3 mm. As such, the second height h₂ may be in the range 0.7 mm to 2.9 mm, for example in the range 0.7 mm to 1.9 mm. The first width w₁ is greater than the second width w₂ by a distance in the range 0.1 mm to 5 mm. As such, the second width w₂ may be in the range 0.1 mm to 6.9 mm, for example in the range 0.1 mm to 5.9 mm. In the embodiments of FIGS. 1 and 2, the distance in the height direction is approximately 0.5 mm, and the distance in the width direction is approximately 0.7 mm.

Distances in the ranges described above have been found to allow the lighting strip 22 to flex within the chamber 20, whilst restricting movement of the lighting strip within the chamber 20. This helps to prevent the lighting strip 22 from twisting and/or rotating such that the lighting strip 22 faces the wrong direction. The restriction helps to prevent the light emitting members from facing in a direction away from the light transmissive cover. For example, without the restriction from the chamber, the lighting strip 22 may twist 90° to face the first or second side walls 18c, 18d, or 180° to face the base wall 18a. This would prevent the light emitting members from transmitting light through the light transmissive cover 18b. The twisting of the lighting strip 22 has been found to be a particular problem at the first and second ends of the elongate body 16. Accordingly, the difference in the first widths w₁, w₂ and the difference in the difference in the first and second heights h₁, h₂ is sized such that the lighting strip 22 is restricted from twisting within the chamber 20. This helps to correctly align the lighting strip 22 with respect to the chamber 20.

It shall be appreciated that in order to prevent the lighting strip 22 from flipping or twisting relative to the chamber 20 such that the lighting strip faces the wrong direction, the first height h₁ may be less than the second width w₂. This helps to prevent the lighting strip 22 from being able to rotate within the chamber 20 such that the light emitting members 25 are prevented from transmitting light through the light transmissive cover 18b.

It shall be appreciated that because the lighting strip 22 is moveable within the chamber 20, the distances between the lighting strip 22 and the base wall 18a, light transmissive cover 18b and first and second side walls 18a, 18b may vary in use. For example, to flex around the corner, the lighting strip 22 may abut against the first side wall 18a and be spaced apart from the second side wall by a distance approximately equal to the difference in the first and second widths w₁, w₂.

In some embodiments, the first and second ends of the flexible elongate body 16 are closed by end covers (not shown). The end covers are arranged such that the chamber is sealed 22. The first and second end covers may be formed from a polymeric material, for example a silicone material or a PVC material. It will be understood that the end covers may be configured to prevent movement of the lighting strip 22 along the elongate length of the body 16. It shall be appreciated that in alternative embodiments, the first and second ends may not be sealed, and the end covers may be omitted.

The flexible elongate body 16 may be formed from a polymeric material. Put another way, the first side wall, the second side wall, the base wall and the light transmissive cover may be formed from a polymeric material. In some arrangements, the first side wall, the second side wall, the base wall may be integrally formed, for example integrally extruded. It will be appreciated that in some embodiments, the cover may be formed from a different material to the first side wall, the second side wall, and the base wall. Examples of suitable material silicone or PVC, but it will be understood that any suitable flexible material may be used in alternative embodiments.

In some embodiments, the first and second side walls 18a, 18b are manufactured from the same material, and the light transmissive cover 18b and the base wall 18b are manufactured from the same material. A co-extrusion process is advantageous for manufacturing the light assembly 10 because multiple different materials may be extruded to form one body.

The light transmissive cover 18b may be configured to diffuse light emitted by the lighting strip 22. Put another way, the light transmissive cover 18b may be configured to diffuse light emitted by the plurality of light emitting members. The light transmissive cover 18b may include a diffusion material for optimising the diffusion of light through the light transmissive cover 18b. The light-diffusion material softens and spreads light, reducing the contrast ratio between hot-spot areas above the light emitting members and the regions between said light emitting members. In some embodiments, the light diffusion material may be applied to the light transmissive cover 18b as a coating. Alternatively, the light diffusion material may be mixed in with the polymer material from which the light transmissive cover 18b is manufactured.

The light-transmissive cover 18b includes an external cover surface 24, or top surface, remote from the base wall 18a. The external cover surface 24 faces outwardly from the chamber 20. The external cover surface 24 substantially extends between the side walls 18c, 18d, for example between the outer face of the side walls 18c, 18d.

The external cover surface 24 is configured and arranged to diffuse light emitted from the light emitting members. The external cover surface 24 may be curved. The curved external cover surface 24 has been found to provide improved light diffusion. It shall be appreciated that in alternative embodiments, the external cover surface 24 may include a non-continuous curve, or an alternative profile suitable for the diffusion of light therethrough. In some embodiments the external cover surface 24 may be continuously curved, for example the external cover surface 24 may be substantially arcuate. In some embodiments, the external cover surface 24 includes a radius of curvature in the range 3 mm to 15 mm, for example in the range 5 mm to 13 mm, for example in the range 7 mm to 30 mm, for example in the range 8 mm to 10 mm, for example approximately 9 mm.

It shall be appreciated that any suitable feature may be used to facilitate the diffusion of light through the light transmissive cover 18b. For example, any of the light diffusion material, the curved exterior surface 24, and/or the translucence of the light transmissive cover 18b may be used alone or in combination to facilitate the diffusion of light through the light transmissive cover.

The base wall 18a defines an exterior base surface 26 that is substantially planar. A width of the base wall 18a in the second direction b may be in the range 3 mm to 10 mm, for example approximately 6.5 mm, although it will be understood that any suitable sized base wall may be used to suit the application. The base wall 18a is substantially transparent or translucent such that the lighting strip 22 is at least partially visible from an exterior side of the lighting assembly 10.

A width between the outermost sides of the first and second side walls 18a, 18b may be in the range 3 mm to 10 mm, for example approximately 6.5 mm, although it will be understood that any suitable sized base wall may be used to suit the application. In the embodiment of FIGS. 1 to 3, the first and second side walls 18a, 18b are opaque, however in alternative embodiments the first and second side walls 18a, 18b may be translucent or transparent.

The lighting strip 22 includes at least one length adjustment formation (not shown) for providing an indication to the user of locations at which the lighting strip 22 may be cut whilst allowing the remaining light emitting members to emit light. As such, the length of the lighting strip 22, and therefore the lighting assembly 10, as a whole, is adjustable depending on the application. The length adjustment formation is offset from the light emitting members. Put another way, the length adjustment formation is positioned away from each light emitting member and between each adjacent pair of light emitting members. The length adjustment formation may be a mark, a detent, a recess or some combination thereof. In this embodiment, a plurality of length adjustment formations are provided in the form of marks, detents and/or recesses located at discrete locations along the lighting strip 22.

The length adjustment formations may be equally spaced apart along the elongate length of the lighting assembly 10. For example, the length adjustment formations may be located between each of the light emitting members. Providing a plurality of locations at which the lighting assembly 10 can be cut without damaging the light emitting members helps to improve the versatility of the lighting assembly 10. The mark, detent or recess may extend at least partially between first and second lateral sides of the lighting strip 22. For example, the mark, detent or recess may be a line extending perpendicularly to the elongate length of the lighting assembly 10 between the first and second lateral sides of the lighting strip 22. Alternatively, the mark, detent or recess may be a dot or a dash. As the base wall 18a of the lighting assembly 10 is substantially transparent or translucent, the length adjustment formation is visible through the base wall 18a. This means that the length of the lighting assembly 10 is adjustable even once the lighting strip 22 is sealed within the flexible elongate body 16.

In the illustrated embodiment, the base wall 18a and side walls 18c, 18d are arranged to define a substantially U-shaped channel. Whilst the first and second side walls 18c, 18d are substantially planar in the illustrated embodiment, it will be appreciated that any suitable shape of wall may be used.

The elongate body 16 includes a mounting arrangement 28a, 28b configured to mount the lighting strip 22 to a lighting support 30 or a lighting support member 32. It shall be appreciated that in alternative embodiments the mounting arrangement 28a, 28b is suitable for use with any lighting assembly. For example, the mounting arrangement 28a, 28b is suitable for use on lighting assemblies without a chamber, and/or wherein the lighting strip is not moveable relative to the elongate flexible body. The support member 32 may be a profiled beam or a plinth for use in a lighting support 30 such as a frame assembly 30. The support member 32 may include a recess or channel for receiving the lighting assembly 10 therein. The support member 32 will be described in more detail below.

In the embodiment of FIG. 2, the first and second side walls 18c, 18d include the mounting arrangement 28a, 28b, illustrated in FIG. 2, configured to mount the lighting assembly 10 to the recess of the support member 32. In the embodiment of FIG. 2, the mounting arrangement is located towards the light transmissive cover 18b, however it shall be appreciated that the mounting arrangement 28a, 28b may be located at any suitable position on the flexible elongate body 16. The mounting arrangement 28a, 28b includes at least one mounting formation, for example a first mounting formation 28a located on the first side wall 18c, and a second mounting formation 28b located on the second side wall 18d. The mounting formations 28a, 28b helps to correctly position the lighting assembly 10 relative to the support member 32.

The first and second mounting formations 28a, 28b each define a wall located towards the light transmissive cover 18b, and the wall is configured to abut against the recess of the lighting support 30. The wall controls the depth of the lighting assembly within the recess, thereby correctly aligning the lighting assembly in the depth direction. In the embodiment of FIG. 2, the light transmissive cover 18b defines the wall. The light transmissive cover 18b has a width greater than the width between the outermost sides of the first and second side walls 18c, 18b so as to define the recess wall.

In the embodiment of FIG. 2, the first and second mounting formations 28a, 28b are recesses defined by the first and second side walls 18c, 18d. The mounting formations 28a, 28b are also defined by the light transmissive cover 18b. Alternatively, the first and second mounting formations 28a, 28b may be grooves or channels. The first and second mounting formations 28a, 28b engage with the recess of the support member 32. The first and second mounting formations 28a, 28b extend at least partially along the elongate length of the flexible elongate body 16. In some embodiments, a series of first and second mounting formations 28a, 28b may be located along the first and second side walls 18c, 18d. The first and second mounting formations 28a, 28b extend parallel to the longitudinal axis of the flexible elongate body 16.

The first and second mounting formations 18c, 18d mount the lighting assembly 10 to the support member 32 without the need for additional mounting components such as an adhesive. Such adhesives have been known to come loose when the lighting assembly 10 heats up, thereby causing the lighting assembly 10 to come loose from the support member 32. The adhesive then needs replacing and the lighting assembly 10 needs to be re-fitted to the support member 32.

In some embodiments, the elongate body 16 may be resiliently deformable. The elongate body 16 may be resiliently deformable along an axis extending between the first and second mounting formations 18c, 18d. Put another way, the elongate body 16 may be resiliently deformable such that the spacing between the first and second mounting formations 18c, 18d is reduced. In some embodiments, only the light transmissive cover 18b and the base 18a of the body 16 may be resiliently deformable such that the body 16 can be laterally compressed. In alternative embodiments, only the side walls of the body 16 may be resiliently deformable such that the body 16 can be laterally compressed. In further alternative embodiments, base, the cover, and the side walls may be resiliently deformable. When the elongate body 16 is resiliently deformable, the lighting assembly 10 has a relaxed state illustrated in FIG. 2, and a deformed or compressed state wherein the first and second side walls 28c, 28d are urged towards one another relative to their position in the relaxed state. Put another way, the body 16 is deformable in a direction towards the central longitudinal axis of the elongate body 16.

Providing a resiliently deformable body 16 helps to facilitate mounting of the lighting strip 22 to the lighting support 30 because the lighting assembly 10 can be mounted via a push-fit arrangement. When the lighting assembly 10 is mounted to the recess or channel of the lighting support 30, the user exerts a force on the first and second side walls 18c, 18d such that the first and second side walls 18c, 18d are urged towards each other and the lighting assembly 10 is in the deformed position. When the lighting assembly 10 is mounted within the recess of the support 30, the force is no longer exerted by the user on the first and second side walls 18c, 18d, and the first and second side walls 18c, 18d move away from each other into the relaxed position of the elongate body 16 illustrated in FIG. 2. When the first and second side walls 18c, 18d move away from each other, they positively engage with the recess of the support member 32. As such, the lighting assembly 10 is mounted to the lighting support via a push-fit mounting arrangement. It shall be appreciated that in alternative embodiments, the lighting assembly 10 may be mounted to the lighting support 30 via a snap-fit mounting arrangement.

In an alternative embodiment of the lighting assembly (not shown) for mounting to a lighting support, the lighting assembly may include the flexible elongate body extending between first and second ends thereof, said body including a base wall, a light transmissive cover, and first and second side walls extending between the base wall and the light transmissive cover. The lighting assembly further includes a lighting strip extending at least partially along the length of the elongate flexible body and located within the elongate flexible body, said lighting strip including a plurality of light emitting members arranged at least partially along the lighting strip. The lighting assembly further includes a mounting arrangement configured to mount the lighting strip to the lighting support 30.

The flexible elongate body is substantially deformable so as to facilitate the mounting of the lighting assembly to the lighting support. In this alternative embodiment, the chamber and the lighting strip may not be dimensioned such that the lighting strip is moveable within the chamber. Put another way, the lighting strip and the chamber may be approximately the same height and width. It shall be appreciated that in this embodiment, any of the above features may be included in the lighting strip, for example the first mounting formation located on the first side wall 18c, and the second mounting formation located on the second side wall. In this embodiment, the base wall, light transmissive cover and first and second side walls may be directly formed around the lighting strip.

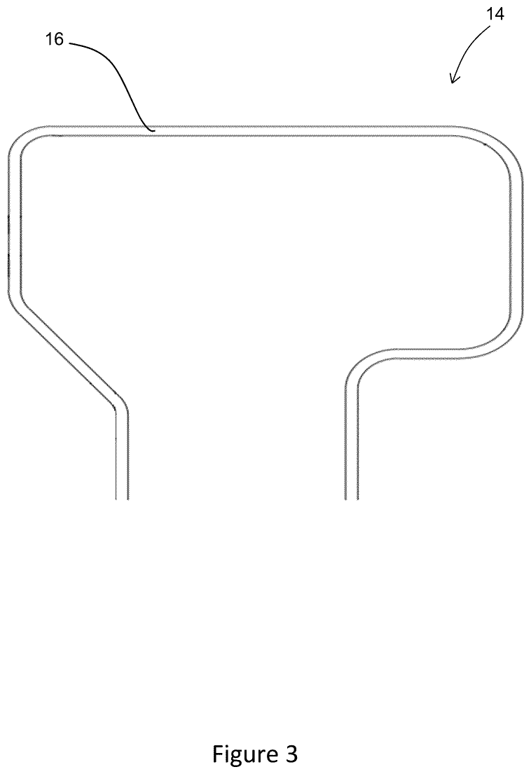

An example of a lighting assembly 10 according to the present teaching is illustrated in FIG. 3. FIG. 3 illustrates an example of how the lighting assembly may flex so as to be routed around the frame assembly or plinth assembly. As illustrated in FIG. 3, a range of different radii of curvature can be achieved by the lighting assembly 10. This helps to ensure that the lighting assembly 10 is appropriate for a range of sizes of lighting assemblies 10 with a range of spatial requirements. For example, the lighting assembly 10 of FIG. 3 is able to achieve a radius of curvature of 15 mm or greater.

A method of assembling the light assembly 10 will not be described. The elongate body 16 is coextruded to form the base wall 18a, the light transmissive cover 18b and the first and second side walls 18c, 18d as an integral elongate flexible body 16.

The base wall 18a is coextruded as a transparent or translucent silicone wall 18a. The light transmissive cover 18b is coextruded with a light diffuser material, or the light diffuser material is applied after the light transmissive cover 18b is coextruded, for example as a coating. The light transmissive cover 18b is extruded with the curved external cover surface 24. The first and second side walls 18a, 18b are coextruded from an opaque silicone material. The coextruded elongate body 16 is open at least one of the first and second ends. The elongate flexible body 16 is coextruded such that the base wall 18a, light transmissive cover 18b and first and second side walls 18c, 18d define the internal elongate chamber 20.

The lighting strip 22 is inserted via the open first or second end of the elongate flexible body 16 and pulled through the internal elongate chamber 20. The lighting strip 22 and the chamber 20 are dimensioned such that the lighting strip 22 is moveable within the chamber 20, for example along axes perpendicular to the elongate length of the body 16. In some embodiments, the flexible elongate body 16 is sealed at the first and second ends with end covers. In addition to sealing the chamber, the end covers may be configured to prevent or restrict movement of the lighting strip 22 along the elongate length of the body 16. The complete enclosure of the lighting strip 22 within the chamber 20 creates a tight seal and makes the lighting assembly 10 IP44 compliant.

An alternative method of assembling the lighting assembly 10 will now be described. An elongate flexible body is formed including the base wall 18a and the first and second side walls 18c, 18d to define a channel. The base wall 18a and the first and second side walls 18c, 18d may be integrally formed, for example extruded, in some embodiments. The lighting strip 22 is positioned in the channel formed by the base wall 18a and first and second side walls 18c, 18b.

The light transmissive cover 18b is applied to the channel formed by the base wall 18a and first and second side walls 18c, 18d to define the internal elongate chamber 20 housing the lighting strip 22. The lighting strip 22 and the chamber 20 are dimensioned such that the lighting strip 22 is moveable within the chamber 20, for example along axes perpendicular to the elongate length of the body 16. In some embodiments, the flexible elongate body 16 is sealed at the first and second ends with end covers. In addition to sealing the chamber, the end covers may be configured to prevent or restrict movement of the lighting strip along the elongate length of the body 16. The complete enclosure of the lighting strip 22 within the chamber 20 creates a tight seal and makes the lighting assembly 10 IP44 compliant.

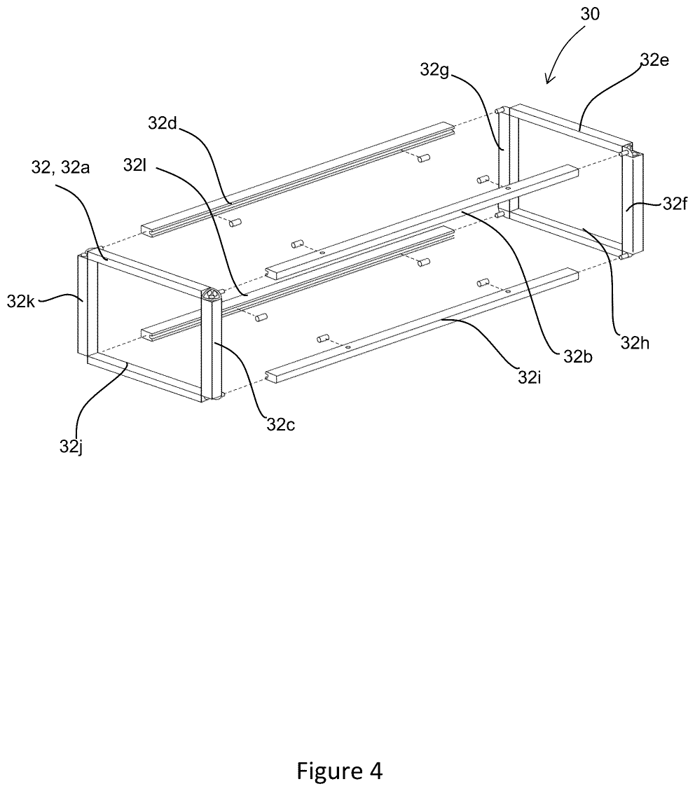

Referring to FIG. 4, an example of a lighting support 30 in the form of a frame assembly is illustrated. The frame assembly 30 is suitable for a range of applications, for example as a display unit or as a table. In alternative embodiments, the lighting support may be a lighting profile for mounting to a plinth or panel. The frame assembly 30 may be made up of a series of elongate profiled support members 32a-l, or a series of plinths. In the illustrated embodiment, twelve profiled support members 32a-l make up a substantially rectangular frame assembly 30.

It shall be appreciated the frame assembly of FIG. 4 is one example, and that in alternative embodiments, any number of support members 32 may be used to construct the frame assembly depending on the required shape and/or size of the frame assembly 30. The frame assembly 30 may support a pane or panel (not shown), such as a pane of glass, a panel of wood, aluminium of another suitable material.

In order to extend around the lighting assembly 30, it is advantageous that the lighting assembly 10 can extend around corners formed by the frame assembly 30. As such, a continuous lighting assembly 10 can be routed around the frame assembly 30 to illuminate the frame assembly 30. The lighting assembly 10 must therefore flex in order to curve around the corners of the frame assembly. Additionally, in order for the lighting assembly 10 to extend around each of the corners, it is advantageous that the lighting assembly 10 can flex in more than one plane.

Each support member 32 is an elongate profiled beam defining opposing ends thereof. Each support member 32 may be a metallic component, i.e., manufactured at least partially from a metallic material. A metallic support member 10 as described here may include features or components of some non-metallic or composite material, such as polymer material. In alternative embodiments, the support member 32 may be a polymeric support member, or any alternative material.

At least one support member 32 includes at least one hollow profile extending along an elongate length of the support member 32. Put another way, the support member 32 defines the recess or channel extending along an elongate length thereof. The support member 32 may include any number of recesses, for example one, two, three, or four recesses.

The frame assembly 30 may include a lighting assembly 10 mounted thereto. The lighting assembly 10 may be mounted to one or more of the support members 32a-l of the frame assembly 30. The lighting assembly 10 is received in the recesses of one or more of the support members 32. The recess of the one or more support members 32 may include a base wall extending between first and second side walls. The base and side walls of the recess define a substantially U-shaped recess. As such, the shape of the recess may correspond to the shape of the base and side walls 28a, 28c, 28d of the lighting assembly 10. The lighting assembly 10 may extend at least partially along the elongate length of the support member 32. In order to power the lighting system, cabling may be routed inside one or more of the support members 32.

The at least one support member 32 includes a first mounting arrangement (not shown) corresponding to the mounting arrangement 28a, 28b of the lighting assembly 10. The first mounting arrangement of the support member 32 and the mounting arrangement 28a, 28b of the lighting assembly 10 include at least one corresponding mounting formation. The at least one mounting formation 28a, 28b of the lighting assembly 10 engage with the at least one light mounting formation of the support member 32 so as to mount the lighting assembly 10 to the support member 32a-l. By way of example, In the embodiment of FIG. 2, wherein the at least one mounting formation 28a, 28b is a recess, the light mounting formation may be a protrusion. The shape of the recess corresponds to the shape of the protrusion. In alternative embodiments, the recess may be located on the support member and the protrusion may be located on the lighting assembly 10.

The resiliently deformable elongate body 16 is particularly advantageous when the support 32 and the lighting assembly 10 both include corresponding mounting formations. This is because the first and second side walls 18c, 18d can be urged towards each other such that the at least one mounting formation 28c, 28d move past the at least one mounting formation of the support member 32 when the lighting assembly 10 is mounted within the recess of the support 32. When the first and second side walls 18c, 18d are released, the at least one mounting formation 28c, 28d of the lighting assembly 10 is urged towards the corresponding at least one light mounting formation of the lighting support. The at least one mounting formation 28a, 28b of the lighting assembly 10 therefore positively engages with the at least one light mounting formation of the support member 32. Thus, the lighting assembly 10 is securely mounted to the lighting support.

Any suitable number of mounting formations may be used to mount the lighting assembly 10 to the lighting support 30. For example, in the embodiment of FIG. 2 where first and second mounting formations 28a, 28b are provided on the first and second side walls 28c, 28d respectively, the support member 32 may include first and second corresponding protrusions. The light mounting formations may extend at least partially along the first and second side walls of the recess of the support member 32. The light mounting formations may extend along the entirety of the recess of the support 32. The light mounting formations may be located towards an edge of the first and second side walls 28c, 28d remote from the base wall of the recess.

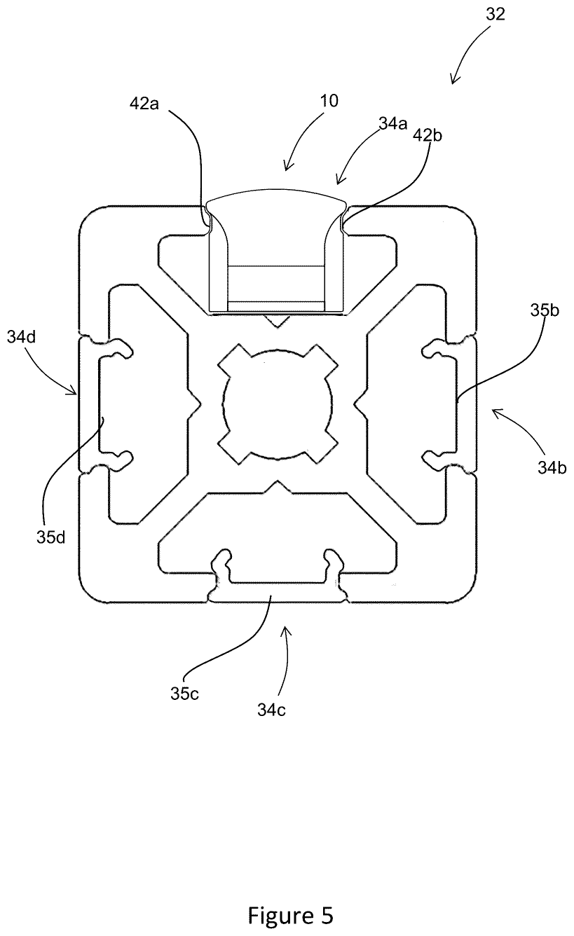

FIG. 5 shows a cross-sectional view of the support member 32 of the lighting support 30. Each support member 32 corresponds to the elongate profiled beam of FIG. 4.

As described above, the support member 32 may include any suitable number of recesses 34a-d. In the embodiment of FIG. 5, four recesses 34a-d are provided. The four recesses 34a-d are each located on a different side of the support member 32. FIG. 5 shows a lighting assembly 10 mounted to one of the four recesses 34a. It shall be appreciated that in alternative embodiments, more than one lighting assembly may be mounted to more than one of the recesses.

In the embodiment of FIG. 5, covers 35b-d are provided for covering the recesses 34b-d to which the lighting assembly 10 is not mounted. The covers 35b-d may be mounted to the recesses 34b-d via any suitable arrangement, for example a snap-fit or a push-fit. The covers 35b-d may include a mounting arrangement corresponding to the light mounting arrangement of the recess, such that the covers 35b-d can be mounted without the need for additional mounting arrangements. FIG. 5 illustrates the light mounting arrangement 42a, 42b described above.

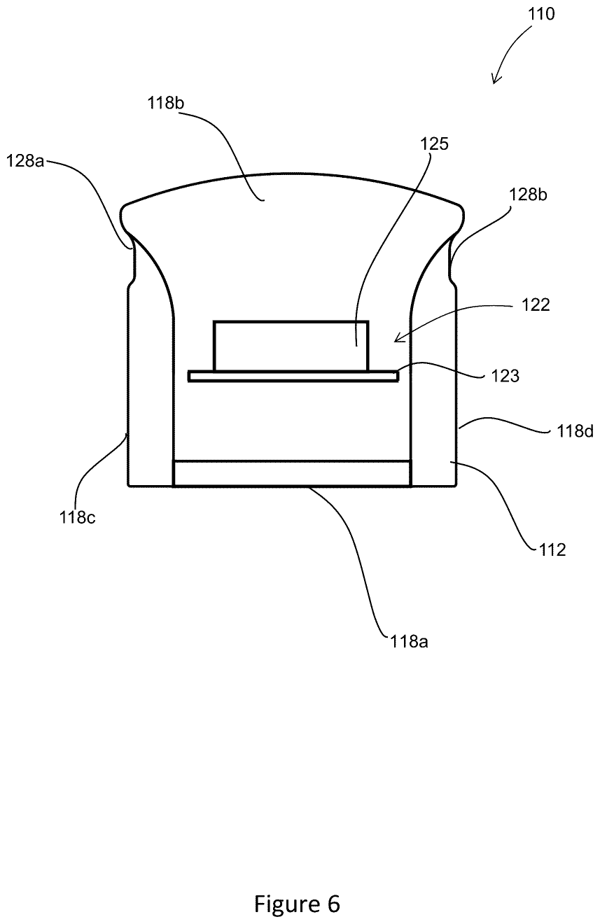

Referring to FIG. 6, a lighting assembly 110 according to an alternative embodiment is illustrated. The lighting assembly 110 includes an elongate body 116 extending between first and second ends thereof. It shall be appreciated that in some embodiments the elongate body 116 may be flexible. It shall be appreciated that flexible is taken to mean a body that is non-rigid. The lighting assembly 110, for example the body 116 of the lighting assembly 110, is configured for mounting to a lighting support 130, such as a frame or a lighting profile for mounting to a plinth or panel.

The elongate body 116 includes a base wall 118a and a light transmissive cover 118b. In the embodiment of FIG. 6, the elongate body 116 includes first and second side walls 118c, 118d extending between the base wall 118a and the light transmissive cover 118b. In the illustrated embodiment, the base wall 118a and the light transmissive cover 118b are parallel to one another, and the first and second side walls 118c, 118b are parallel to one another. It shall be appreciated that in alternative embodiments the base wall 118a, light transmissive cover 118b and first and second side walls 118c, 118d may be angled relative to one another or may be curved etc.

The lighting assembly 110 includes a lighting strip 122 extending at least partially along the elongate body 116. The lighting strip 122 has an elongate body 123. The lighting strip 122 is located within or connected to the elongate body 116 of the lighting assembly 110 so as to be at least partially covered by the light transmissive cover 118b. The elongate body 116 may surround the lighting strip 122 such that there is substantially no clearance between internal wall of the elongate body 116 and the lighting strip 122. This helps to prevent the lighting strip 122 from twisting and/or rotating such that the lighting strip 122 faces the wrong direction. The restriction helps to prevent the lighting strip 122 from facing in a direction away from the light transmissive cover 118b. For example, without the restriction from the body 116, the lighting strip 122 may twist 90° to face the first or second side walls 118c, 118d, or 180° to face the base wall 118a. This would prevent the lighting strip from transmitting light through the light transmissive cover 118b.

The lighting strip 122 includes a plurality of light emitting members 125 arranged at least partially along a length of the lighting strip 122, for example entirely along the length of the lighting strip 122. The light emitting members may, by way of example, be light emitting diodes, incandescent bulbs or florescent bulbs. Any suitable number of light emitting members may be distributed along the lighting strip 122 depending, for example, on the required length of the lighting strip 122. In some embodiments, the light emitting members may be evenly distributed along the lighting strip 122, in other embodiments the light emitting members may be unevenly distributed along the lighting strip 122.

The elongate body 116 may be formed from a polymeric material. Put another way, the first side wall 118c, the second side wall 118d, the base wall 118a and/or the light transmissive cover 118b may be formed from a polymeric material. In some arrangements, the first side wall 118c, the second side wall 118d, the base wall 118a may be integrally formed, for example integrally extruded. It will be appreciated that in some embodiments, the light transmissive cover 118b may be formed from a different material to the first side wall 118c, the second side wall 118d, and the base wall 118a. Examples of suitable material silicone or PVC, but it will be understood that any suitable flexible material may be used in alternative embodiments.

In some embodiments, the first and second side walls 118c, 118d are manufactured from the same material, and the light transmissive cover 118b and the base wall 118a are manufactured from the same material. A co-extrusion process is advantageous for manufacturing the light assembly 110 because multiple different materials may be extruded to form one body. In the embodiment of FIG. 6, the light transmissive cover 118b is substantially planar, however it shall be appreciated that it may include any of the features of the light transmissive cover 18b of FIG. 1.

The elongate body 116 includes a mounting arrangement 128a, 128b configured to mount the lighting assembly 122 to the lighting support 130. It shall be appreciated that in alternative embodiments, the mounting arrangement 128a, 128b is suitable for use with any lighting assembly, for example the lighting assembly 10 of FIG. 1, or with a light assembly having any suitable combination of the features of the lighting assemblies of FIGS. 1 and 5. For example, the mounting arrangement 128a, 128b is suitable for use on lighting assemblies with a chamber, and/or wherein the lighting strip 122 is moveable relative to the elongate body 116. The lighting support 130 may be a frame assembly or a plinth assembly. The lighting support 130 includes a recess or channel 134 for receiving the lighting assembly 110 therein. The lighting support 130 will be described in more detail below.

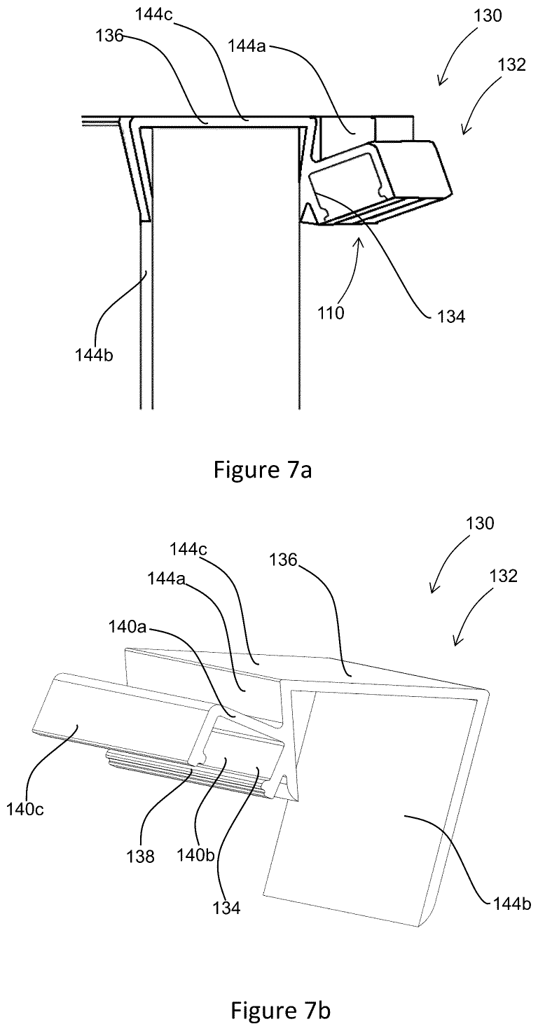

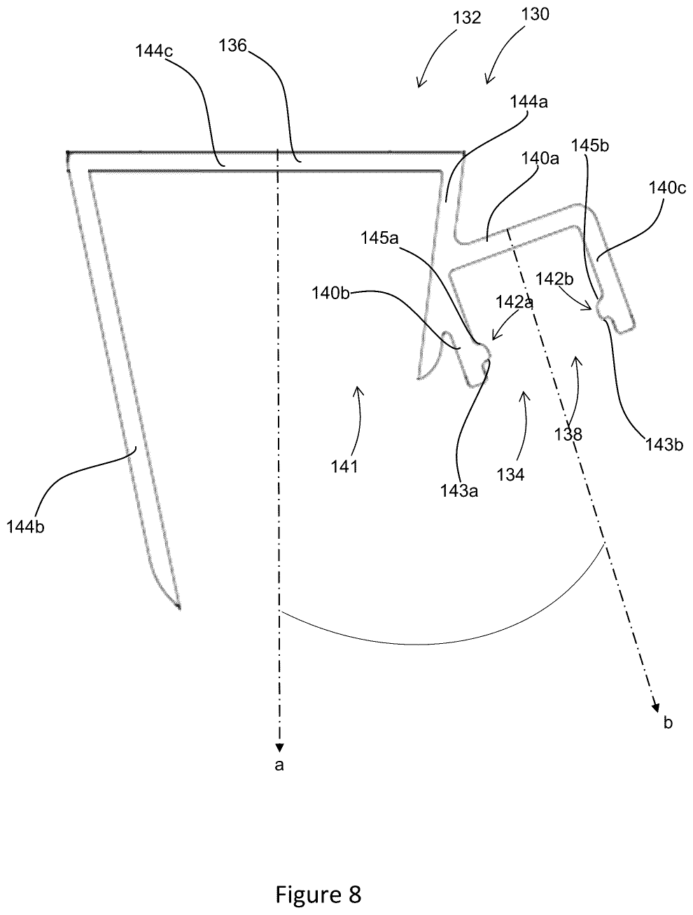

In the embodiment of FIG. 6, the first and second side walls 118c, 118d include the mounting arrangement 128a, 128b, illustrated in FIG. 6, configured to mount the lighting assembly 110 to the recess of the support member 10. FIG. 7a shows the lighting assembly 110 mounted to the lighting support 130.

In the embodiment of FIG. 6, the mounting arrangement 128a, 128b is located towards the light transmissive cover 118b, however it shall be appreciated that the mounting arrangement 128a, 128b may be located at any suitable position on the elongate body 116. The mounting arrangement 128a, 128b includes a first mounting formation 128a located on an outer surface of the elongate body 116. The first mounting formation 128a may be arranged on a first lateral side of the elongate body 116. A second mounting formation 128b may be provided on an outer surface of the elongate body 116. The second mounting formation 128b may be arranged on a second lateral side of the elongate body 116 opposite the first lateral side. It shall be appreciated that in some embodiments, the second mounting formation 128b may be omitted.

In the embodiment of FIG. 6, the first mounting formation 128a is located on the first side wall 118c, and the second mounting formation 128b is located on the second side wall 118d. It shall be appreciated that in alternative embodiments, the mounting formation 128a, 128b may be located on opposing lateral sides of the base wall 118a. The mounting formations 128a, 128b help to correctly position the lighting assembly 110 relative to the lighting support 130.

The first and second mounting formations 128a, 128b each define a shoulder configured and arranged to abut against the lighting support 130 when the lighting assembly 110 is mounted to the lighting support 130. The shoulder is located towards the light transmissive cover 118b, and the shoulder is configured to abut against a recess 134 of the lighting support 130. The shoulder controls the depth of the lighting assembly 110 within the recess 134, thereby correctly aligning the lighting assembly in the depth direction. In the embodiment of FIG. 6, the light transmissive cover 118b defines the shoulder. The light transmissive cover 118b has a width greater than the width between the outermost sides of the first and second side walls 118c, 118b so as to define the shoulder.

In the embodiment of FIG. 6, the first and second mounting formations 128a, 128b are recesses defined by the first and second side walls 118c, 118d. The mounting formations 128a, 128b are also defined by the light transmissive cover 118b. Alternatively, the first and second mounting formations 128a, 128b may be grooves or channels. The first and second mounting formations 128a, 128b engage with the recess 134 of the lighting support 130. The first and second mounting formations 128a, 128b extend at least partially along the elongate length of the flexible elongate body 116. In some embodiments, a series of first and second mounting formations 128a, 128b may be located along the first and second side walls 118c, 118d. The first and second mounting formations 128a, 128b extend parallel to the longitudinal axis of the elongate body 116.

The first and second mounting formations 128a, 128b mount the lighting assembly 110 to the lighting support 130 without the need for additional mounting components such as an adhesive. Such adhesives have been known to come loose when the lighting assembly 110 heats up, thereby causing the lighting assembly 110 to come loose from the support member 110. The adhesive then needs replacing and the lighting assembly 110 needs to be re-fitted to the support member 110.

In some embodiments, the elongate body 116 may be resiliently deformable. The elongate body 116 is resiliently deformable along an axis substantially perpendicular to the first mounting formation 128a. In embodiments where the mounting arrangement 128a, 128b includes a first mounting formation 128a on the first lateral side of the elongate body 116, the elongate body 116 may be resiliently deformable along a lateral axis. In embodiments where the mounting arrangement comprises a second mounting formation 128b on the second lateral side of the elongate body 116 opposite the first lateral side, the body may be resiliently deformable along an axis extending between the first and second mounting formations.

In the embodiment of FIG. 6, the elongate body 116 is resiliently deformable along an axis extending between the first and second mounting formations 128a, 128b. Put another way, the elongate body 116 is resiliently deformable such that the spacing between the first and second mounting formations 128a, 128b is reduced. In some embodiments, only the light transmissive cover 118b and the base 118a of the body 116 may be resiliently deformable such that the body 116 can be laterally compressed. In alternative embodiments, only the side walls of the body 116 may be resiliently deformable such that the body 116 can be laterally compressed. In further alternative embodiments, the base 118a, the light transmissive cover 118b cover, and the first and second side walls 1180, 118d may be resiliently deformable.

When the elongate body 116 is resiliently deformable, the lighting assembly 114 has a relaxed state illustrated in FIG. 6, and a deformed or compressed state wherein the first and second side walls 118c, 118d are urged towards one another relative to their position in the relaxed state. Put another way, the body 116 is deformable in a direction towards the central longitudinal axis of the elongate body 116.

Providing a resiliently deformable body 116 helps to facilitate mounting of the lighting strip 122 to the lighting support 130 because the lighting assembly 110 can be mounted via a push-fit arrangement. When the lighting assembly 110 is mounted to the recess or channel of the lighting support 130, the user exerts a force on the first and second side walls 118c, 118d such that the first and second side walls 118c, 118d are urged towards each other and the lighting assembly 110 is in the deformed position. When the lighting assembly 114 is mounted within the recess of the lighting support 130, the force is no longer exerted by the user on the first and second side walls 118c, 118d, and the first and second side walls 118c, 118d move away from each other into the relaxed position of the elongate body 116 illustrated in FIG. 6. When the first and second side walls 118c, 118d move away from each other, they positively engage with the recess of the lighting support 130. As such, the lighting assembly 110 is mounted to the support via a push-fit. It shall be appreciated that in alternative embodiments, the lighting assembly 110 may be mounted to the lighting support 130 via a snap-fit.

Referring to FIGS. 7a and 7b, an example of a lighting support 130 in the form of part of a plinth 130 is illustrated. It shall be appreciated that the lighting support 130 may be made up of a number of support members 132. It shall be appreciated that any suitable number of supports may be used to make up the lighting support 130. Accordingly, the teachings relating to the lighting support 130 may also be applied to support members 132 used to make a lighting support 130. The terms lighting support 130 and support member 132 may therefore be used interchangeably. The lighting support 130 is suitable for a range of applications, for example for mounting to a separate support such as a plinth body, as will be described in more detail below. Alternatively, the lighting support 130 may be mounted to a splash board.

Each lighting support 130 has an elongate body 136 defining opposing ends thereof. Each support member 132 may be a metallic component, i.e., manufactured at least partially from a metallic material. A metallic support member 132 as described here may include features or components of some non-metallic or composite material, such as polymer material. In alternative embodiments, the support member 132 may be a polymeric support member, or any alternative material.

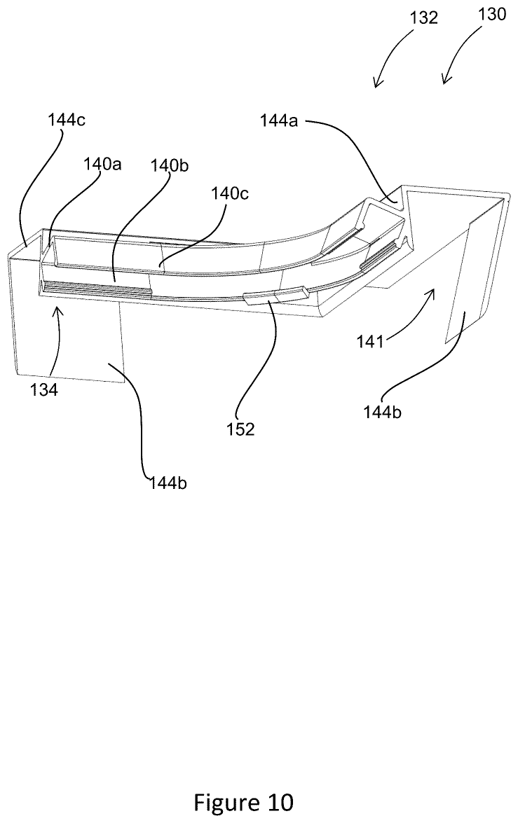

The lighting support 130 includes the elongate recess 134 extending at least partially along the elongate length of the elongate body 136. The recess 134 has the lighting assembly 110 mounted thereto. In the embodiments of FIGS. 7a to 11, the support member 132 further includes a plinth or panel mounting arrangement 144a, 144b for mounting the support member 132 to the separate support (not shown). The plinth or panel mounting arrangement 144a, 144b includes first and second opposing arms 144a, 144b extending from the elongate body 116 to define a channel 141 configured to receive a part of a plinth or a panel therein to mount the lighting support 130 to said plinth or panel. The first arms 144a and second arms 144b are arranged such that the channel 141 tapers in a direction away from the elongate body.

The lighting support 130 is deformable such that the first and the second arms 144a, 144b are deflectable relative to each other, as will be described in more detail below. In some embodiments, a single lighting assembly 110 may be mounted to the lighting support 130, however in alternative embodiments a plurality of lighting assemblies may be mounted to the support.

The support member 132 may include any number of recesses 134 for mounting the lighting assembly 110 thereto. The recess 134 defines an opening 138 for receiving the lighting assembly 110. The recess defines first and second opposing recess side walls 140b, 140c extending at least partially along the elongate length of the body. The recess 134 includes a base wall 140a extending between the first and second recess side walls 140b, 140c. The base and side walls 140a-c of the recess 134 define a substantially U-shaped recess 134. As such, the shape of the recess 134 may correspond to the shape of the base and side walls 118a, 1180, 118d of the lighting assembly 110. It shall be appreciated that in alternative embodiments, any suitable shape of recesses may be used. The opening 138 is located at an edge of the first and second side walls 140b, 140c of the recess 134 remote from the base wall 140a.

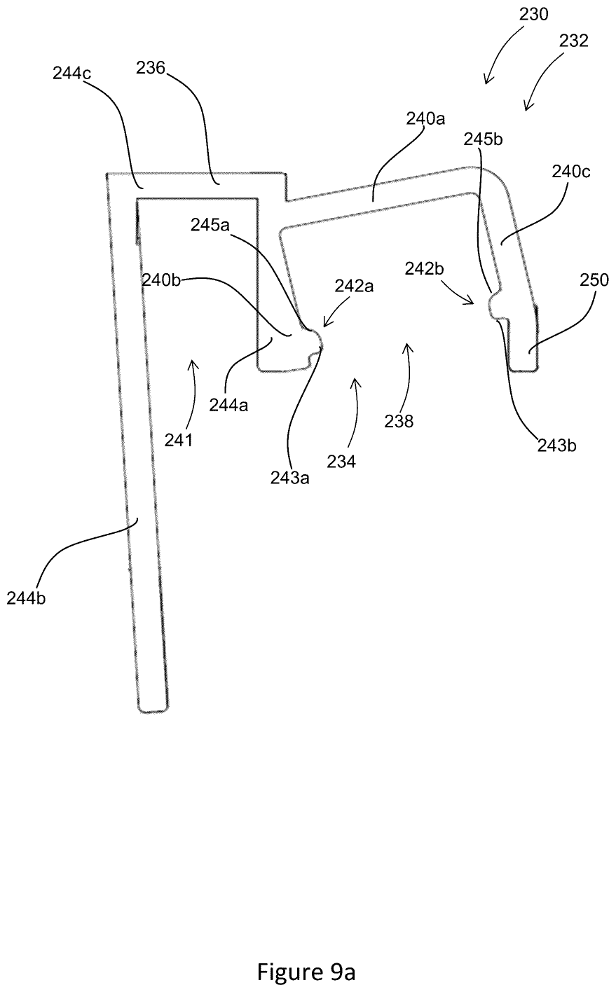

The recess 134 includes the lighting mount 142a, 142b configured for mounting the light assembly 110 thereto. The lighting mount 142a, 142b is configured to releasably mount the lighting assembly 110 to the support member 132. The lighting mount 142a, 142b includes a first light mounting formation 142a located on a first lateral side of the recess 134 and/or a second light mounting formation 142b located on a second lateral side of the recess 134. In the embodiment of FIGS. 7a to 8, the first light mounting formation 142a is located on the first side wall 140b and the second light mounting formation 142b is located on the second side wall 140c. It shall be appreciated that in alternative embodiments, the first and/or second mounting formations may be located on opposing lateral sides of the base wall 140a.

The first and second light mounting formations 142a, 142b engage with the first and second mounting formations of 118a, 118b of the lighting assembly 110. The first and second light mounting formations 142a, 142b are located towards the edge of the first and second side walls 140b, 140c remote from the base wall 140a. Put another way, the first and second mounting formations 142a, 142b are located closer to the opening 138 than to the base wall 140a. In alternative embodiments, the first and second light mounting formations 142a, 142b may be located at any suitable location on the first and second side walls 140b, 140c.

In some embodiments, a plurality of spaced apart first light mounting formations 142a may be provided along the first side wall 140b in the form of a plurality of spaced apart first protrusions 142a. A plurality of spaced apart light mounting formations 142b may be provided along the second side wall 140c in the form of a plurality of spaced apart second protrusions 142b. The plurality of spaced apart first and second light mounting formations 142a, 142b may, by way of example, be provided with an equal spacing between adjacent light mounting formations 142a, 142b of the respective first and second light mounting formations 142a, 142b. Alternatively, by way of example, two first light mounting formations and two second light mounting formations may be provided. The first lighting formations 142a may be arranged at opposing ends of the recess 134, and the second mounting formations 142b may be arranged at opposing ends of the recess 134. It shall be appreciated that any number of mounting formations with any suitable spacing may be used to mount the lighting assembly 110 to the support member 132.

Although any suitable number of first and second light mounting formations 142a, 142b may be used, for reasons of conciseness and brevity only one first mounting formation 142a and one second mounting formations 142b will be described hereafter. It shall be appreciated that any combination of the features of the first and second mounting formations described hereafter are applicable to the plurality of spaced apart first and second mounting formations 142a, 142b.

The first mounting formation 142a is a protrusion 142a at least partially defined by the first side wall 140b. It shall therefore be appreciated that the terms “first mounting formation” and “first protrusion” may be used interchangeably. The second mounting formation 142b is a protrusion 142b at least partially defined by the second side wall 140c. It shall therefore be appreciated that the terms “second mounting formation” and “second protrusions” may be used interchangeably. The second protrusion 142b is arranged to substantially oppose the first protrusion 142a on the first recess wall 140b.

The first and second protrusions 142a, 142b correspond to the shape of the first and second recesses 128a, 128b of the lighting assembly 110. A minimum distance between the first and second protrusions 142a, 142b may be in the range 2 mm to 15 mm, for example in the range 3 mm to 9 mm. Distances in the given ranges correspond to the width of the lighting assembly 110, and help to ensure the mounting arrangements 128a, 128b, 142a, 142b engage. It shall be appreciated that in alternative embodiments, the first and second light mounting formations 142a, 142b may be recesses and the first and second mounting formations 128a, 128b may be protrusions. Alternatively, any suitable shape of mounting formations 128a, 128b, 142a, 142b may be used.

As illustrated in FIG. 8, the first protrusion 142a includes a first external wall 143a located towards the opening of the recess 134, and a first internal wall 145a located towards the base wall 140a of the recess 134. The second protrusion 142b includes a second external wall 143b located towards the opening of the recess 134, and a second internal wall 145b located towards the base wall 140a of the recess 134. The first and second internal and external walls 143a, 145a, 143b, 145b, are located on opposing sides of the respective first and second protrusions 142a, 142b. The first and second internal walls 145a, 145b are chamfered. The chamfers of the first and second internal walls 145a, 145b extend from the respective first or second side wall 140b, 140c of the recess 134 and towards the external walls 143a, 143b.

The first and second external walls 143a, 145a extend substantially perpendicularly to the respective first or second side wall 140b, 140c of the recess 134. It shall be appreciated that in alternative embodiments, the first and second external walls 143a, 145a may extend at any suitable angle relative to the respective first or second side wall 140b, 140c. For example, the first and second external walls 143a, 145a may be chamfered. The chamfers of the first and second external walls 143a, 145a may extend from the respective first or second side wall 140b, 140c of the recess 134 towards the internal walls 143b, 145b. It shall be appreciated that in alternative embodiments, any suitable shape of first and second protrusion 142a, 142b may be used.

The profiles of the first and second internal and external walls 143b, 145b, 143a, 145a are particularly useful during removal of the lighting assembly 110 when the body 116 of the lighting assembly 110 is resiliently deformable. As described above in relation to the embodiment of FIGS. 1 to 3, to insert the lighting assembly 110 the body 116 is compressed and released such that the mounting arrangement 128a, 128b of the lighting assembly 110 positively engages with the lighting mount 142a, 142b of the support member 132. However, the side walls 140b, 140c of the recess 134 prevent the lighting assembly 110 from being compressed to remove the lighting assembly 110 from the support. The chamfered edge of the first and second internal profiles 143b, 145b compresses the lighting assembly 110 and guides the lighting assembly 110 thereon.

The plinth or panel mounting arrangement 144a, 144b of one embodiment is illustrated in FIGS. 6a to 9. The plinth or panel mounting arrangement 144a, 144b may be provided to mount the support member 132 to the separate support (not shown). In the embodiments of FIGS. 6a to 9, wherein the support member 132 is a plinth 132, the separate support may be a plinth body. Alternatively, the separate support may be a splash board. The support may include any suitable form of corresponding support mounting arrangement.

In the embodiment of FIG. 8, the plinth or panel mounting arrangement includes the first arm 144a and the second arm 144b. The first and second arms 144a, 144b are connected by an intermediate wall 144c such that the first and second arms 144a, 144b and the intermediate wall 144c define the channel 141 for receiving the support. A width extending between outermost surfaces of the intermediate wall may be in the range 3 mm to 30 mm, for example in the range 5 mm to 25 mm. In the embodiment of FIG. 8, the width of the intermediate wall 144c is in the range 16 mm to 24 mm. The first arm 144a and the second arm 144b are configured to deform relative to one another. In alternative embodiments, one of the first and second arm 144a, 144b may be rigid and the other of the first and second arm 144a, 144b may be configured to deform.

The first arm 144a and the second arm 144b engage with the separate support. The first arm 144a and the second arm 144b grip the separate support in order to mount the support member 132 to the support.

The first and second arms 144a, 144b define a relaxed state, and in the relaxed state the first and second arms 144a, 144b extend towards one another. Put another way, the first and second arms 144a, 144b are biased towards each other in the relaxed state. A first acute angle is defined between the first arm 144a and the intermediate wall 144c. A second acute angle is defined between the second arm 144b and the intermediate wall 144c. The first and second acute angle may be in the range 10° to 85°, for example in the range 30° to 60°. The first and second acute angles may be any value within this range. The first acute angle may be a different value to the second acute angle. In order to mount the support member 132 to the support, a force is exerted on the deformable first and second arms 144a, 144b to urge the first and second arms 144a, 144b away from one another. The support, or a support mounting formation of the support, is inserted between the first and second arms 144a, 144b.

When the force on the first and second arms 144a, 144b is released, the first and second arms 144a, 144b move back into the relaxed position and exert a gripping force the support to mount the support member 132 to the support.

In the embodiment of FIGS. 7a, 7b and 8, at least a portion of the recess 134 is parallel to the channel 141 formed by the first and second arms 144a, 144b. The entirety of the recess 134 may be parallel to the channel 141 formed by the first and second arms 144a, 144b. In embodiments where the recess 134 and the channel are substantially straight; their respective longitudinal axes may be parallel. The intermediate wall 144c of the channel 141 is substantially planar and define a plane. The base wall and side walls 140a-c of the recess 134 do not extend outside of the plane of the intermediate wall 144c. This helps to ensure that the support 130 is compact and the first mounting arrangement 142a, 142b fits within the spatial restrictions of the support member 130.

It shall be appreciated that in alternative embodiments, any suitable first and second arms may be used, for example a push-fit arrangement or a snap-fit arrangement.

The channel 141 is arranged at a non-zero angle relative to the recess 134. The recess 134 defines an axis a normal to an elongate opening of the recess 134, illustrated in FIG. 8. The channel 141 defines an axis b normal to an elongate opening of the channel 141, illustrated in FIG. 8.

The axis a of the recess 134 is arranged at a non-zero angle to the axis b of the channel 141. Put another way, the opening of the recess 134 faces away from the first and second arms 144a, 144b. The non-zero angle may be any angle between 5° and 90°, for example between 20° and 75°. The non-zero angle may be between 30° and 50°. The relative angle of the first and second arms 144a, 144b to the recess 134 also angles the lighting assembly 110 relative to the first and second arms 144a, 144b, and therefore to the support. This helps to improve aesthetics of the support and produce a more desirable dispersion of light. The angle may also be varied depending on the application.

The recess 134 is mounted to the first and/or second arms 144a, 144b. In the embodiment of FIG. 8, the recess 134 is mounted to the first arm 144a. The recess 134 extends at a non-zero-angle from the first arm 144a. The first side wall 140b of the recess 134 extends from the first arm 144a such that the first arm 144a partially defines the first side wall 140b and a portion of the first side wall 140b is spaced apart from the first arm 144a. In alternative embodiments, the first arm 144a may define the entirety of the first side wall 140b. It shall be appreciated that in alternative embodiments, the recess 134 may extend from the second arm 134b. Alternatively, the recess 134 may be located on an alternative part of the support member 132. The lighting mount 142a, 142b and the first and second arms 144a, 144b may be connected by an intermediate body or arm.

The first and second arms 144a, 144b each define a height, and the height of the second arm 144b is greater than the height of the first arm 144a. It shall be appreciated that in alternative embodiments, the height of the first and seconds arms 144a, 144b may be the same, or the height of the first arm 144a may be greater than the height of the second arm 144b.

FIGS. 8a and 8b show alternative embodiments of the support member 232, 332. Like parts are labelled with the prefix “2” and “3” respectively. The embodiments of FIGS. 8a and 8b illustrate that different sizes of recess and channel are possible, as well as a range of length of arms and relative angles. It shall be appreciated that the embodiments of FIGS. 8a and 8b are two of many possible embodiments of support member covered by the scope of the present teachings.

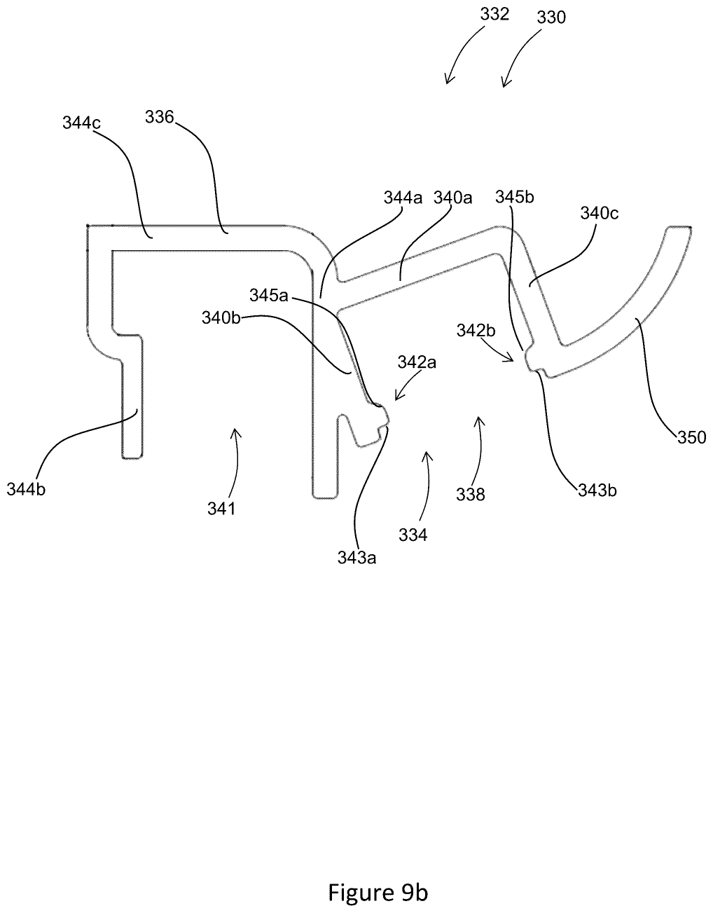

In the embodiment of FIG. 9a, the width of the intermediate wall 244c is less than the width of the intermediate wall 144c. The width of the intermediate wall 244c is in the range 3 mm to 10 mm. The width of the intermediate wall 244c is less than a width of the recess 234 extending between the innermost surfaces of the first and second walls 240b, 240c. Additionally, the first arm 244a defines the entirety of the first wall 240b of the recess 234. The second wall 240c of the recess 234 defines a deviation in profile at the end remote from the base wall 240a. The deviation in profile 250 extends towards the first side wall 240b.

In the embodiment of FIG. 9b, the height of the first arm 344a is greater than the height of the second arm 344b. The second arm 344b includes a first portion, and a second portion axially offset from the first portion. It shall be appreciated that the first arm and/or the second arm of any embodiment of support may be of any suitable shape depending on the application. The shape of the first and second arms defines the shape of channel for receiving the support, therefore any suitable shape of first and second arm and channel may be used to mount the support to the support depending on the shape of the support. The first arm 344a defines a majority of the first wall 340b of the recess 334, thereby illustrating that the first arm may define any proportion of the first wall of the recess. The second wall 340c of the recess defines a deviation in profile at the end remote from the base wall 340a. The deviation in profile 350 extends in a direction away from the first side wall 340b. The deviation in profile 350 is substantially curved.

FIG. 11 shows a specific embodiment of the support member 132 wherein the support member 132 is configured to extend around a corner. It shall be appreciated that any of the cross-section of support member 132, 232, 332 may be suitable for extending around corners as illustrated in FIG. 11. The recess 134 extends along a non-linear path. The recess 134 extends along a curved path. This helps to mount the lighting assembly 10 at the corners and ensure the lighting assembly 110 is emitting light at the corners.

In the embodiment of FIG. 11, two first mounting formations 142a provided and two second mounting formations 142b are provided. The two first mounting formations 142a, and the two second mounting formations 142b are spaced apart. The spacing is such that the mounting formations are not present as the recess extends around the corner. This may help to reduce damage to the lighting assembly 110 and increase the possible angles of the corner. This is because movement of the lighting assembly 110 is not restricted at the corner, meaning that the lighting assembly 110 has additional space to flex or move into. The mounting formations 142a, 142 may cause damage to the lighting assembly 110 if they restrict movement of the lighting assembly 110 at the corner. The additional allowable movement of the lighting assembly may further increase the flexibility of the lighting assembly relative to the lighting support 130 and enable use in corners with tighter spatial restrictions. It shall be appreciated that the embodiment of FIG. 11 may be suitable for use with the lighting assembly of FIG. 2.

The recess 134 includes a ledge 152 extending at least partially over the opening 138 of the recess 134. The ledge 152 extends from or near a distal end of the first and/or second side wall 140b, 140c to extend at least partially between said first and second side walls 140b, 140c. The ledge 152 at least partially extends between adjacent protrusions 142a, 142b. The ledge helps to restrict movement of the lighting assembly out of the recess 134. In FIG. 1, the ledge 152 is located at the corner. It shall be appreciated that a series of ledges 152 may be provided, and the ledge 152 may be located at any suitable location on the corner. Alternatively, the ledge 152 may be used on substantially linear supports 130 to serve the same purpose of restricting movement of the lighting assembly 110 out of the recess 134.

The ledge 152 is particularly useful in embodiments wherein, in use, the lighting support 130 is orientated such that the opening 138 of the recess 134 faces in a generally downward direction (i.e., towards a ground surface). Without the ledge 152 acting on the lighting assembly 110, the lighting assembly 110 may fall out of the recess 134 under the influence of gravity. The ledge 152 therefore supports the lighting assembly 110 and helps to prevent the lighting assembly 110 from falling out of the recess 134. It shall be appreciated that any suitable formation may be used in place of the ledge, for example a protrusion.

In FIG. 11, although the recess 134 follows a non-linear path, the first and second arms 144a, 144b of the channel 141 follow a substantially linear path. The recess 134 is therefore mounted to the first or second arm 144a, 144b at a first and second location, and free from the first or second arm 144a, 144b in the space therebetween. It shall be appreciated that any proportion of the recess 134 may be connected to the first or second arm 144a, 144b. For example, the recess 134 may be connected to the first and second arms 144a-c along an entire length thereof. In further alternative embodiments, the recess 134 may extend around the corner in linear sections. For example, the recess 134 may extend around the corner such that the recess 134 and the first and second arms 144a-c follow parallel paths. In such embodiments, separate lighting mounting arrangements 110 may be mounted to the respective linear sections forming the corner. This may be particularly advantageous if the lighting assembly 110 does not have the required flexibility to bend round the corner.

In the embodiment of FIG. 11, the first arm 144a is continuous, and the second arms 144b is provided as a first section and a second section. In alternative embodiments, the second arm 144b may be continuous, and or/the first arm 144a may be provided in sections. Any suitable number of sections may be used to form the first and/or second arm 144a, 144b.

It shall be appreciated that in alternative embodiments, the lighting assembly 110 may include the chamber of FIG. 1, and any combination of the associated features. Additionally, the lighting assembly 110 may include and/or omit any combination of the features of the lighting assembly of FIG. 1, for example the end covers, the features of the light transmissive cover, the features of the base wall, and/or the length adjustment formation. For reasons of conciseness and brevity, these features have not been described in detail. Furthermore, it is submitted that the lighting assembly 10 of FIG. 1, or any alternative lighting assembly, is suitable for use in any of the supports of FIGS. 7a to 11. The support may be used for any suitable application to which a support may be mounted. The frame and plinth of the Figures are two of many possible examples.

Although the teachings have been described above with reference to one or more preferred embodiments, it will be appreciated that various changes or modifications may be made without departing from the scope as defined in the appended claims.

What is claimed is:

1. A lighting support for mounting to a plinth or a panel, the lighting support comprising:
an elongate body defining opposing ends thereof;
first and second opposing arms extending from the elongate body to define a channel configured to receive a part of a plinth or a panel therein to mount the lighting support to said plinth or panel; and
a lighting mount connected to the body and comprising an elongate recess defining first and second opposing side walls extending at least partially along the elongate length of the body;
wherein the first recess wall comprises a protrusion configured to engage a recess, groove or channel of a lighting assembly to mount a lighting assembly in the recess.

2. The lighting support according to claim 1, wherein the first and second arms are arranged wherein the channel tapers in a direction away from the elongate body.

3. The lighting support according to claim 1, wherein the lighting support is deformable wherein the first and second arms are deflectable relative to each other.

4. The lighting support according to claim 1, wherein the channel is arranged at a non-zero angle relative to the recess; optionally wherein an axis normal to an elongate opening of the channel is arranged at a non-zero angle to an axis normal to an elongate opening of the recess.

5. The lighting support according to claim 1, wherein the first and second arms each define a respective height, the height of the second arm being greater than the height of the first arm, and wherein the recess is on the first arm.

6. The lighting support according to claim 1, wherein the second recess wall comprises a protrusion configured to engage a recess, groove or channel of a lighting assembly to mount a lighting assembly in the recess, said protrusion arranged to substantially oppose the protrusion on the first recess wall.

7. The lighting support according to claim 1, wherein the protrusion on the first recess wall and/or second recess wall define an external wall located towards the opening of the recess and an interior wall located towards the base wall of the recess, and wherein the internal wall is chamfered; and/or wherein the external wall extends substantially perpendicularly to the first or second wall.

8. The lighting support according to claim 1, wherein the first recess wall comprises a plurality of spaced apart protrusions configured to engage the recess, groove or channel of a lighting assembly to mount a lighting assembly in the recess.

9. The lighting support according to claim 8, wherein the recess comprises a ledge extending from or near a distal end of the first and/or second wall to extend at least partially between said first and second walls; optionally wherein the ledge at least partially extends between adjacent protrusions.

10. A lighting assembly for mounting to a lighting support, the lighting assembly comprising:
a flexible elongate body extending between first and second ends thereof, said body comprising a base wall, and a light transmissive cover;
a lighting strip extending at least partially along the flexible elongate body and located within or connected to the elongate flexible body so as to be at least partially covered by the light transmissive cover;
wherein the body comprises a mounting arrangement configured to mount the lighting strip to the support;
wherein the mounting arrangement comprises a first mounting formation on an outer surface of the elongate body, said mounting formation comprising a recess, groove or channel on the outer surface of the body.

11. The lighting assembly according to claim 10, wherein the first mounting formation is arranged on a first lateral side of the body, and wherein the body is resiliently deformable along a lateral axis.

12. The lighting assembly according to claim 10, wherein the mounting arrangement comprises a second mounting arrangement on a second lateral side of the body opposite the first lateral side and wherein the body is resiliently deformable along an axis extending between the first and second mounting formations; optionally wherein the second mounting formation comprises a recess, groove or channel.

13. The lighting assembly according to claim 10, wherein the light transmissive cover and/or the base of the flexible elongate body are resiliently deformable wherein the body can be laterally compressed; and/or wherein the body comprises first and second side walls extending between the base wall and the light transmissive cover, wherein the side walls of the flexible elongate body are resiliently deformable such that the body can be laterally compressed.

14. The lighting assembly according to claim 10, wherein each mounting formation defines a shoulder configured and arranged to abut against the support when the lighting assembly is mounted to the lighting support.

15. The lighting assembly according to claim 10, wherein the mounting arrangement is a push-fit or snap-fit mounting arrangement.

16. The lighting assembly according to claim 10, wherein the body defines an internal elongate chamber extending between the first and second ends, and wherein the lighting strip extends at least partially along the chamber; optionally wherein the lighting strip and the chamber are dimensioned such that the lighting strip is moveable within the chamber; and optionally wherein the lighting strip and the chamber are dimensioned such that the lighting strip is moveable within the chamber along an axis substantially perpendicular to the elongate axis of the body.

17. The lighting assembly according to claim 16, wherein the lighting strip and the chamber are dimensioned such that the lighting strip is moveable within the chamber along a first axis extending between the light transmissive cover and the base wall, and/or along a second axis extending between the first and second side walls.

18. The lighting assembly according to claim 16, wherein the lighting strip and the chamber are dimensioned to prevent the light strip from twisting and/or rotating such that the light emitting members face in a direction away from the light transmissive cover.

19. The lighting assembly according to claim 18, wherein the chamber defines a first height along a first axis extending between the base wall and the cover, and the lighting strip defines a second width extending along a second axis extending between the first and second side walls, and wherein the second width is greater than the first height.

20. A lighting device comprising the lighting support according to claim 1, further comprising a lighting assembly according to claim 10 mounted in the recess of the lighting mount of the lighting support.
